(19) United States
(12) Patent Application Publication
(10) Pub. No.: US 2026/0309889 A1
(43) Pub. Date: Oct. 8, 2026

(54) CONTACT DETERMINATION APPARATUS

(71) Applicant: ALPS ALPINE CO., LTD., Tokyo (JP)

(72) Inventors: Takashi SASAKI, Miyagi (JP); Kazuhito OSHITA, Miyagi (JP); Ken KAMAGATA, Miyagi (JP); Satoshi TERASHITA, Miyagi (JP)

(21) Appl. No.: 19/463,761

(22) Filed: Jan. 29, 2026

Related U.S. Application Data
(63) Continuation of application No. PCT/JP2024/008239, filed on Mar. 5, 2024.

(30) Foreign Application Priority Data
Aug. 10, 2023 (JP) 2023-131375

(51) Int. Cl. G01V 3/15; B62D 1/06; G01V 3/08

(52) U.S. Cl. CPC G01V 3/15; B62D 1/06; G01V 3/08

(57) ABSTRACT

A contact determination apparatus includes a detection electrode having first and second end portions positioned at both ends and provided along a contact portion; a shield electrode provided facing the detection electrode and capacitively coupled to the detection electrode; an alternating current signal outputter configured to output an alternating current signal to the detection electrode or the shield electrode; a first wire connected to the first end portion of the detection electrode; a second wire connected to the second end portion of the detection electrode; and a determiner configured to determine presence or absence of an abnormality in the detection electrode based on a first output signal that is output from the first wire and a second output signal that is output from the second wire, and determine that a detection target is in contact with the contact portion based on the first output signal or the second output signal.

### CROSS-REFERENCE TO RELATED APPLICATIONS

This application is a continuation application of International Application No. PCT/JP2024/008239 filed on Mar. 5, 2024, and designated the U.S., which is based upon and claims priority to Japanese Patent Application No. 2023-131375 filed on Aug. 10, 2023, the entire contents of which are incorporated herein by reference.

### BACKGROUND

### 1. Technical Field

The present disclosure relates to a contact determination apparatus.

### 2. Description of Related Art

Conventionally known is a capacitance detection device (contact determination apparatus) that detects a capacitance between a target and a detection electrode, the device having: a first capacitor disposed in the path between a first node connected to the detection electrode and a second node; a second capacitor disposed in the path between the first node and the ground; a third capacitor disposed in the path between the first node and a third node connected to a shield electrode placed in proximity to the detection electrode; an alternating current voltage output circuit that outputs a first alternating current voltage to the third node; a first attenuation circuit that outputs a second alternating current voltage resulting from attenuating the amplitude of the first alternating current voltage; and a charge amplifier that supplies charge to the first capacitor through the second node and outputs a detection signal matching the supplied charge. The charge amplifier supplies the charge to the first capacitor so that a voltage generated at the second node approaches the second alternating current voltage. This capacitance detection device (contact determination apparatus) can detect, based on an amplitude of a voltage of the detection signal, an open state in which at least one of a path between the detection electrode and the first node or a path between the shield electrode and the third node is electrically disconnected (for example, see International Publication No. WO 2021/225061, hereinafter “Patent Document 1”).

A capacitance detection device detects a capacitance between a target and a detection electrode placed close to a shield electrode. The capacitance detection device has a first detection signal creation unit that has a plurality of detection nodes connected to a plurality of detection electrodes in one-to-one correspondence through a plurality of second wires, supplies charge from the detection node through the second wire to the detection electrode so that the voltage at the detection node vibrates according to the alternating current voltage, and creates a plurality of first detection signals matching the supplied charge. The first filter is provided in each of the plurality of first paths, each of which branches from the alternating current output node to one of the plurality of first wires. The second detection signal creation unit multiplies the first detection signal by an alternating current signal to create a second detection signal. The phase difference signal creation unit multiplies the first detection signal by a signal having a phase different by 90 degrees from the alternating current voltage to create a phase difference signal in accordance with the phase difference. This capacitance detection device (contact determination apparatus) can easily distinguish between the proximity of a target and an occurrence of a breakage in a part of a plurality of wires connected to a shield electrode (for example, see International Publication No. WO 2022/074963, hereinafter “Patent Document 2”).

### SUMMARY

A contact determination apparatus according to an embodiment of the present disclosure includes a detection electrode having a first end portion and a second end portion positioned at both ends and provided along a contact portion; a shield electrode provided facing the detection electrode and capacitively coupled to the detection electrode; an alternating current signal outputter configured to output an alternating current signal to the detection electrode or the shield electrode; a first wire connected to the first end portion of the detection electrode; a second wire connected to the second end portion of the detection electrode; and a determiner configured to determine presence or absence of an abnormality in the detection electrode based on a first output signal that is output from the first wire and a second output signal that is output from the second wire, and determine that a detection target is in contact with the contact portion based on the first output signal or the second output signal.

### BRIEF DESCRIPTION OF THE DRAWINGS

FIG. 1 is a diagram schematically illustrating a steering wheel implemented with a contact determination apparatus of an embodiment;

FIG. 2A is a diagram illustrating a circuit configuration example of a sensor electrode, a shield electrode, and an interface circuit of the contact determination apparatus of the embodiment;

FIG. 2B is a diagram illustrating an example of an equivalent circuit when the sensor mat is operating normally;

FIG. 3A is a graph illustrating an example of a simulation result using the equivalent circuit of FIG. 2B;

FIG. 3B is a graph illustrating an example of a simulation result using the equivalent circuit of FIG. 2B;

FIG. 3C is a graph illustrating an example of a simulation result using the equivalent circuit of FIG. 2B;

FIG. 3D is a graph illustrating an example of a simulation result using the equivalent circuit of FIG. 2B;

FIG. 3E is a graph illustrating an example of a simulation result using the equivalent circuit of FIG. 2B;

FIG. 3F is a graph illustrating an example of a simulation result using the equivalent circuit of FIG. 2B;

FIG. 4A is a graph illustrating an example of a simulation result using the equivalent circuit of FIG. 2B;

FIG. 4B is a graph illustrating an example of a simulation result using the equivalent circuit of FIG. 2B;

FIG. 4C is a graph illustrating an example of a simulation result using the equivalent circuit of FIG. 2B;

FIG. 4D is a graph illustrating an example of a simulation result using the equivalent circuit of FIG. 2B;

FIG. 4E is a graph illustrating an example of a simulation result using the equivalent circuit of FIG. 2B;

FIG. 4F is a graph illustrating an example of a simulation result using the equivalent circuit of FIG. 2B;

FIG. 5 is a diagram illustrating an example of the state where the sensor electrode is broken at a first end portion side of the sensor electrode;

FIG. 6A is a graph illustrating an example of a simulation result where the sensor electrode is in the state illustrated in FIG. 5;

FIG. 6B is a graph illustrating an example of a simulation result where the sensor electrode is in the state illustrated in FIG. 5;

FIG. 6C is a graph illustrating an example of a simulation result where the sensor electrode is in the state illustrated in FIG. 5;

FIG. 6D is a graph illustrating an example of a simulation result where the sensor electrode is in the state illustrated in FIG. 5;

FIG. 6E is a graph illustrating an example of a simulation result where the sensor electrode is in the state illustrated in FIG. 5;

FIG. 6F is a graph illustrating an example of a simulation result where the sensor electrode is in the state illustrated in FIG. 5;

FIG. 7A is a graph illustrating a result according to the embodiment on a plane of real and imaginary signals;

FIG. 7B is a graph illustrating a result according to a comparative example on a plane of real and imaginary signals;

FIG. 8 is a diagram illustrating an example where a crack has formed in the sensor electrode;

FIG. 9 is a diagram illustrating an example of an equivalent circuit from an alternating current signal source to a differential amplifier when a crack has formed in the sensor electrode;

FIG. 10A is a graph illustrating an example of a result of a simulation performed using the equivalent circuit illustrated in FIG. 9 in the state where a small crack has formed in the sensor electrode;

FIG. 10B is a graph illustrating an example of a result of a simulation performed using the equivalent circuit illustrated in FIG. 9 in the state where a small crack has formed in the sensor electrode;

FIG. 10C is a graph illustrating an example of a result of a simulation performed using the equivalent circuit illustrated in FIG. 9 in the state where a small crack has formed in the sensor electrode;

FIG. 10D is a graph illustrating an example of a result of a simulation performed using the equivalent circuit illustrated in FIG. 9 in the state where a small crack has formed in the sensor electrode;

FIG. 10E is a graph illustrating an example of a result of a simulation performed using the equivalent circuit illustrated in FIG. 9 in the state where a small crack has formed in the sensor electrode;

FIG. 10F is a graph illustrating an example of a result of a simulation performed using the equivalent circuit illustrated in FIG. 9 in the state where a small crack has formed in the sensor electrode;

FIG. 11A is a graph illustrating an example of a result of a simulation performed using the equivalent circuit illustrated in FIG. 9 in the state where a large crack has formed in the sensor electrode;

FIG. 11B is a graph illustrating an example of a result of a simulation performed using the equivalent circuit illustrated in FIG. 9 in the state where a large crack has formed in the sensor electrode;

FIG. 11C is a graph illustrating an example of a result of a simulation performed using the equivalent circuit illustrated in FIG. 9 in the state where a large crack has formed in the sensor electrode;

FIG. 11D is a graph illustrating an example of a result of a simulation performed using the equivalent circuit illustrated in FIG. 9 in the state where a large crack has formed in the sensor electrode;

FIG. 11E is a graph illustrating an example of a result of a simulation performed using the equivalent circuit illustrated in FIG. 9 in the state where a large crack has formed in the sensor electrode;

FIG. 11F is a graph illustrating an example of a result of a simulation performed using the equivalent circuit illustrated in FIG. 9 in the state where a large crack has formed in the sensor electrode;

FIG. 12 is a diagram illustrating exaggerated signal A at point A;

FIG. 13 is a diagram illustrating exaggerated signal B at point B;

FIG. 14A is a graph illustrating a simulation result representing waveforms in the state where the sensor electrode is broken at the first end portion side as illustrated in FIG. 5;

FIG. 14B is a graph illustrating a simulation result representing waveforms in the state where the sensor electrode is broken at the first end portion side as illustrated in FIG. 5;

FIG. 14C is a graph illustrating a simulation result representing waveforms in the state where the sensor electrode is broken at the first end portion side as illustrated in FIG. 5;

FIG. 14D is a graph illustrating a simulation result representing waveforms in the state where the sensor electrode is broken at the first end portion side as illustrated in FIG. 5;

FIG. 14E is a graph illustrating a simulation result representing waveforms in the state where the sensor electrode is broken at the first end portion side as illustrated in FIG. 5;

FIG. 14F is a graph illustrating a simulation result representing waveforms in the state where the sensor electrode is broken at the first end portion side as illustrated in FIG. 5;

FIG. 15 is a diagram illustrating an example of a real part and an imaginary part in a detection circuit when the sensor electrode is broken;

FIG. 16 is a diagram illustrating an exaggerated relationship between the waveforms of the voltages input to the detection circuit when a hand is not in proximity to the sensor electrode and when the sensor electrode is broken;

FIG. 17 is a diagram illustrating an example of an equivalent circuit of the sensor electrode and the shield electrode when a crack has formed in the sensor electrode;

FIG. 18 is a diagram illustrating an example of a waveform of signal B;

FIG. 19 is a diagram illustrating the equivalent circuit when a crack has formed in the sensor electrode;

FIG. 20 is a diagram illustrating an example of a real part and an imaginary part when a crack has formed;

FIG. 21A is a diagram illustrating an example of coordinates of a first detection signal and a second detection signal in a complex plane and results of abnormality determination and contact determination;

FIG. 21B is a diagram illustrating an example of coordinates of a first detection signal and a second detection signal in a complex plane and results of abnormality determination and contact determination;

FIG. 21C is a diagram illustrating an example of coordinates of a first detection signal and a second detection signal in a complex plane and results of abnormality determination and contact determination;

FIG. 21D is a diagram illustrating an example of coordinates of a first detection signal and a second detection signal in a complex plane and results of abnormality determination and contact determination;

FIG. 22A is a flowchart showing an example of processing performed by a determiner of the contact determination apparatus of the embodiment;

FIG. 22B is a flowchart showing an example of processing performed by a determiner of the contact determination apparatus of the embodiment;

FIG. 22C is a flowchart showing an example of processing performed by a determiner of the contact determination apparatus of the embodiment;

FIG. 23A is a diagram illustrating an example of how the sensor electrode is mounted on a rim;

FIG. 23B is a diagram illustrating an example of how the sensor electrode is mounted on a rim;

FIG. 24 is a diagram illustrating a circuit configuration example of a sensor electrode, a shield electrode, and an interface circuit of a contact determination apparatus of a modified example of the embodiment;

FIG. 25A is a diagram illustrating a modified example of how the sensor electrode is mounted on a rim; and

FIG. 25B is a diagram illustrating a modified example of how the sensor electrode is mounted on a rim.

### DETAILED DESCRIPTION

In the capacitance detection device (contact determination apparatus) of Patent Document 2, the presence or absence of proximity or contact by a hand or the like is determined based on a change in impedance of the detection electrode. However, when damage such as a crack occurs in the detection electrode, the impedance of the detection electrode changes in the same manner; accordingly, there is a possibility that it will not be possible to distinguish between the presence or absence of contact by a hand and the occurrence of damage to the detection electrode.

It is possible to provide a contact determination apparatus capable of distinguishing between the presence or absence of contact by a hand or the like and the occurrence of damage such as a crack to the detection electrode.

Hereinafter, an embodiment to which the contact determination apparatus of the present disclosure is applied will be described.

### Embodiment

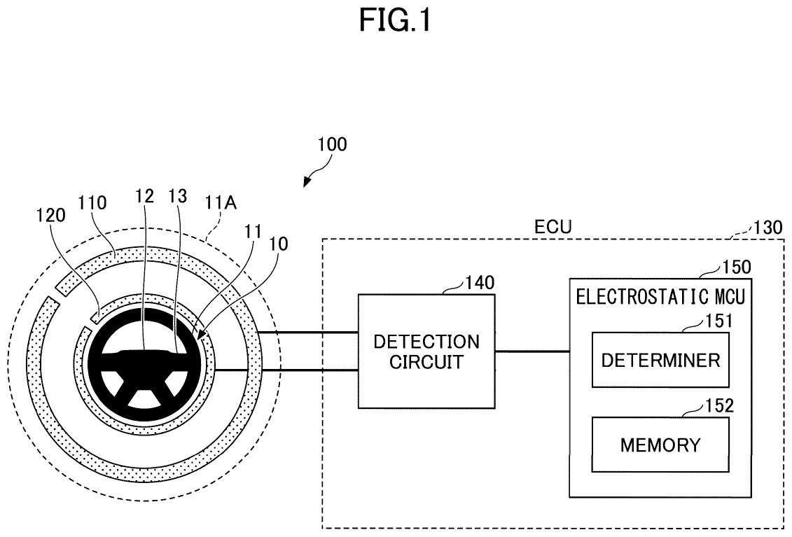

FIG. 1 is a diagram schematically illustrating a steering wheel 10 implemented with a contact determination apparatus 100 of the embodiment. The steering wheel 10 is mounted on a vehicle, and a sensor electrode 110 and a shield electrode 120 of the contact determination apparatus 100 are provided inside a surface layer of a rim 11. The sensor electrode 110 is an example of a detection electrode. The contact determination apparatus 100 determines whether or not the driver's hand H is in contact with the rim 11 of the steering wheel 10. The contact determination apparatus 100 also determines whether or not an abnormality, such as a crack, has occurred in the sensor electrode 110. The hand H is an example of a detection target. The rim 11 of the steering wheel 10 is an example of a fixation target to which the sensor electrode 110 and the shield electrode 120 are fixed. A surface layer 11A of the rim 11 is an example of a contact portion with which a detection target can be in contact.

Hereinafter, a vehicle driver is referred to as an “operator” of the contact determination apparatus 100. The description will be made regarding the contact determination apparatus 100 that determines whether or not an abnormality, such as a crack, has occurred in the sensor electrode 110 and determines whether or not an operator's hand H as a detection target is in contact with the surface layer 11A of the rim 11 of the steering wheel 10 provided with the sensor electrode 110. The operator's act of touching the rim 11 of the steering wheel 10, in which the sensor electrode 110 is provided, is referred to as an “operator's operation” hereinafter.

The steering wheel 10 has the rim 11, a hub 12, and spokes 13. What is illustrated in FIG. 1 as the rim 11, the hub 12, and the spokes 13 are core metal (core metal) portions of the rim 11, the hub 12, and the spokes 13. In FIG. 1, the surface layer 11A of the rim 11 is shown separated from the rim 11 so that the sensor electrode 110 and the shield electrode 120 are shown. In FIG. 1, the covers covering the hub 12 and the spokes 13 are omitted.

A ground terminal of the steering wheel 10 is electrically connected to the core metal provided along the entire circumference of the rim 11 of the steering wheel 10. By connecting the core metal and the ground terminal of an ECU 130 via a connector (not illustrated), the ground potential of the ECU 130 becomes equal to the ground potential of the steering wheel 10.

### Structure of Contact Determination Apparatus 100

The contact determination apparatus 100 includes the sensor electrode 110, the shield electrode 120, and the ECU 130 (electronic control unit). The ECU 130 has a detection circuit 140 and an electrostatic MCU (microcontroller unit) 150. The detection circuit 140 is connected to the sensor electrode 110 and the shield electrode 120 via a cable and a connector (not illustrated).

The sensor electrode 110 is provided along a circumference of the rim 11 of the steering wheel 10 while being insulated from the core metal provided along the entire circumference of the rim 11 of the steering wheel 10. The sensor electrode 110 is connected to the ECU 130 via a signal line. The sensor electrode 110 is a thin, sheet-like, belt-shaped electrode provided along the entire circumference of the rim 11, and can be manufactured, for example, by applying a conductor such as silver paste on the surface of a resin film.

Similar to the sensor electrode 110, the shield electrode 120 is a thin, sheet-like, belt-shaped electrode provided along the entire circumference of the rim 11 of the steering wheel 10 in a state of being overlapped with the sensor electrode 110. The shield electrode 120 is disposed between the sensor electrode 110 and the core metal, and is provided along the entire circumference of the rim 11 of the steering wheel 10 in a state of being insulated from the core metal and the sensor electrode 110 by a resin film. The shield electrode 120 is connected to the ECU 130 via a signal line. The shield electrode 120 is a thin, sheet-like, belt-shaped electrode provided along the entire circumference of the rim 11, and can be manufactured by, for example, applying a conductor such as silver paste on the surface of the resin film. The shield electrode 120 may be formed on the rear surface of the resin film on which the sensor electrode 110 is provided.

The shield electrode 120 can improve detection accuracy by reducing parasitic capacitance with the core metal and suppressing leakage of current from the sensor electrode 110 to objects other than the hand H.

The ECU 130 is provided inside an instrument panel as an example. The ECU 130 has the detection circuit 140 and the electrostatic MCU 150.

The detection circuit 140 is connected to the sensor electrode 110 and the shield electrode 120, applies a sine wave (input sine wave) to the shield electrode 120, converts the sine wave in accordance with the capacitive components associated with the sensor electrode 110 and the hand H and the resistive component associated with the sensor electrode 110, and outputs an output sine wave. In other words, to briefly describe, the detection circuit 140 obtains a signal mainly corresponding to the impedance of the sensor electrode 110 and the shield electrode 120, such as the capacitance value (electrostatic capacitance) of the sensor electrode 110 and the hand H or a breakage in the sensor electrode 110, from the difference between the input sine wave and the output sine wave, respectively, multiplies a signal that is in phase with the input sine wave by a signal having a phase shifted by half a wavelength, integrates the resultant signal, converts the resultant signal into an AD value, and outputs the resultant signal to the electrostatic MCU 150. The AD value is represented by a count value having no unit, as an example.

The electrostatic MCU 150 is implemented by a computer including a CPU (central processing unit), a RAM (random access memory), a ROM (read only memory), an input/output interface, an internal bus, and the like. An ECU (not illustrated) for controlling electronic devices of the vehicle on which the steering wheel 10 is mounted is connected to the electrostatic MCU 150 as an example. The ECU of the vehicle may be, for example, an electronic device for automatic operation of the vehicle.

The electrostatic MCU 150 has a determiner 151 and a memory 152. The determiner 151 represents a function of a program executed by the electrostatic MCU 150 as a function block. The memory 152 functionally represents the memory of the electrostatic MCU 150.

The determiner 151 determines whether or not the driver's hand H is in contact with the rim 11 of the steering wheel 10, and also determines whether or not an abnormality, such as a crack, has occurred in the sensor electrode 110. Details of the determination processing performed by the determiner 151 will be described later.

The memory 152 stores programs and data necessary for the determiner 151 to perform the processing.

### Circuit Configuration

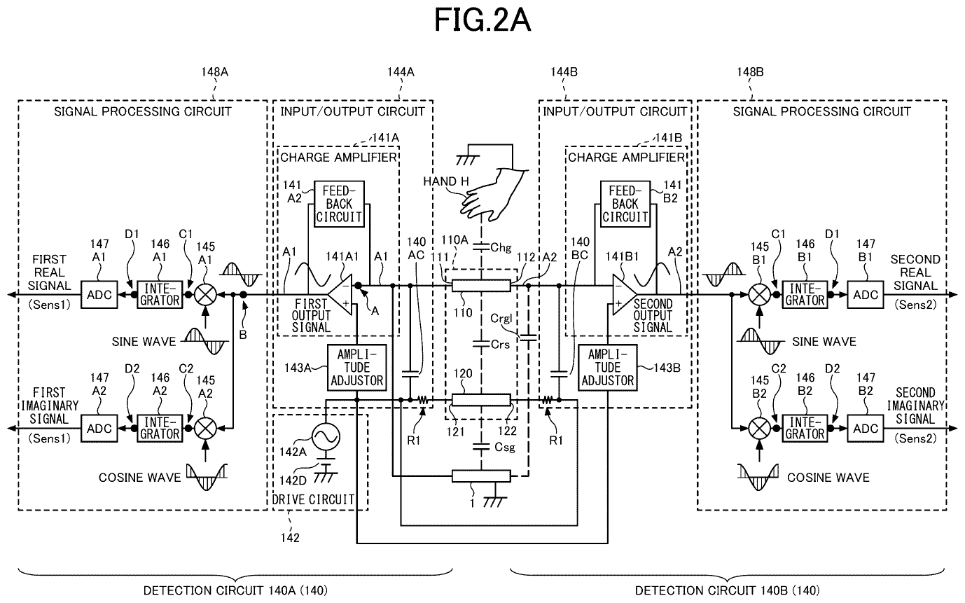

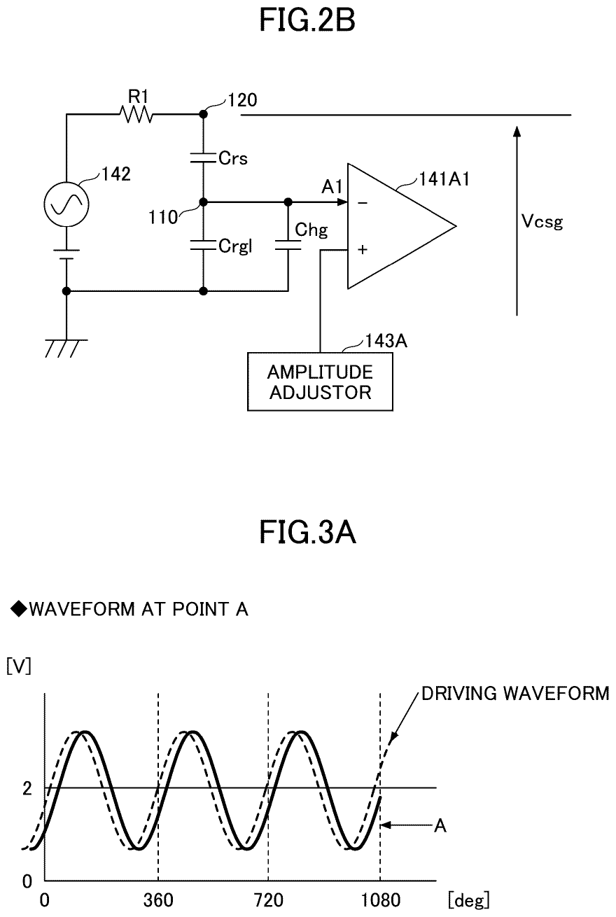

FIG. 2A is a diagram illustrating an example of the circuit configuration of the sensor electrode 110, the shield electrode 120, and the detection circuit 140.

### Sensor Electrode 110 and Shield Electrode 120

The sensor electrode 110 and the shield electrode 120 are thin sheet-like and belt-shaped electrodes and formed on a resin film, and constitute a sensor 110A in a state of being overlapped with each other, with the resin film being interposed therebetween. The sensor electrode 110 and the shield electrode 120 are arranged to face each other, with the resin film being interposed therebetween. Hereinafter, the left end side of the sensor electrode 110 in FIG. 2A is referred to as the “first end portion 111”, and the right end side is referred to as the “second end portion 112”. Similarly, the left end side of the shield electrode 120 is referred to as the “first end portion 121”, and the right end side is referred to as the “second end portion 122”. The sensor electrode 110 and the shield electrode 120 overlap and face each other in the area between the first end portions 111 and 121 and the second end portions 112 and 122. Therefore, the sensor electrode 110 and the shield electrode 120 are electromagnetically coupled. In other words, they are capacitively coupled.

FIG. 2A illustrates the hand H and a ground 1 in addition to the sensor electrode 110, the shield electrode 120, and the detection circuit 140. The ground 1 is a ground potential portion of the core metal or the like of the steering wheel 10 and has the same potential as the vehicle body.

Hereinafter, the capacitance between the hand H and the sensor electrode 110 is “Chg”, the capacitance between the sensor electrode 110 and the shield electrode 120 is “Crs”, the capacitance (stray capacitance) between the sensor electrode 110 and the ground 1 is “Crgl”, and the capacitance between the shield electrode 120 and the ground 1 is “Csg”. The sensor electrode 110 and the shield electrode 120 are collectively referred to as the “sensor unit”. Since the human body can be regarded as a conductor, the hand H can be regarded as having the same potential as the ground 1.

### Detection Circuit 140

The detection circuit 140 is divided into a detection circuit 140A and a detection circuit 140B. In FIG. 2A, the detection circuits 140A and 140B are symmetrically arranged on the left and right sides of the sensor electrode 110 and the shield electrode 120. The detection circuits 140A and 140B are equivalent circuits, and the detection circuit 140A has a circuit partially in common with the circuit disclosed in Patent Document 2.

The detection circuit 140A has a drive circuit 142, an input/output circuit 144A for applying voltages to the sensor electrode 110 and the shield electrode 120 and causing the sensor electrode 110 to output signals, and a signal processing circuit 148A for processing the output signals from the input/output circuit 144A. The input/output circuit 144A has a capacitor 140AC, a charge amplifier 141A, an amplitude adjustor 143A, and a resistor R1, and the charge amplifier 141A has a differential amplifier 141A1 and a feedback circuit 141A2.

The signal processing circuit 148A has a multiplier 145A1, a multiplier 145A2, an integrator 146A1, an integrator 146A2, an ADC (analog-to-digital converter) 147A1, and an ADC 147A2.

The wire A1 connecting the first end portion 111 of the sensor electrode 110 to the charge amplifier 141A is an example of a first wire. The charge amplifier 141A is an example of a first charge amplifier. The drive circuit 142 is an example of an alternating current signal outputter. The amplitude adjustor 143A is an example of a first attenuation circuit. The multiplier 145A1 is an example of a first multiplication circuit. The multiplier 145A2 is an example of a second multiplication circuit. The integrator 146A1 is an example of a first integration circuit. The integrator 146A2 is an example of a second integration circuit.

The detection circuit 140B includes a drive circuit 142, an input/output circuit 144B for applying voltages to the sensor electrode 110 and the shield electrode 120 and outputting signals from the sensor electrode 110, and a signal processing circuit 148B for signal processing of signals from the input/output circuit 144B. The input/output circuit 144B has a capacitor 140BC, a charge amplifier 141B, an amplitude adjustor 143B, and a resistor R1, and the charge amplifier 141B has a differential amplifier 141B1 and a feedback circuit 141B2. The signal processing circuit 148B has a multiplier 145B1, a multiplier 145B2, an integrator 146B1, an integrator 146B2, an ADC 147B1, and an ADC 147B2. The detection circuit 140B is similar to the detection circuit 140A.

The wire A2 connecting the second end portion 112 of the sensor electrode 110 to the charge amplifier 141B is an example of a second wire. The charge amplifier 141B is an example of a second charge amplifier. The amplitude adjustor 143B is an example of a second attenuation circuit. The multiplier 145B1 is an example of a third multiplication circuit. The multiplier 145B2 is an example of a fourth multiplication circuit. The integrator 146B1 is an example of a third integration circuit. The integrator 146B2 is an example of a fourth integrating circuit.

### Circuit Configuration of Detection Circuit 140A

An outline of an operation will be described. A signal that is output from the drive circuit 142 is input to the sensor unit and changes through the sensor unit. A difference between a signal that is input to the sensor unit and a signal that is output from the sensor unit is output from a differential amplifier, and the output signal is processed by the signal processing circuit 148A to obtain a capacitive component and a resistive component of the sensor unit.

### Drive Circuit 142

The drive circuit 142 has a direct current signal source 142D and an alternating current signal source 142A connected in series, and outputs an alternating current signal of a positive potential for driving the shield electrode 120. The output terminal of the alternating current signal source 142A is connected to the first end portion 121 and the second end portion 122 of the shield electrode 120 and the input terminals of the amplitude adjustor 143A and the amplitude adjustor 143B, and the alternating current signal is supplied to the shield electrode 120, the amplitude adjustor 143A, and the amplitude adjustor 143B. The output potential of the alternating current signal source 142A is an example of an output potential of the drive circuit 142, and the output terminal of the alternating current signal source 142A is an example of an output potential point of the drive circuit 142. In the present embodiment, the voltage of the direct current signal source 142D is set to 2 V.

### Input/Output Circuit 144A

### Capacitor 140AC

The capacitor 140AC is connected between the first end portion 111 of the sensor electrode 110 and the first end portion 121 of the shield electrode 120.

The capacitor 140AC is provided for electromagnetic compatibility (EMC), and noise entering from the sensor electrode 110 is input to the inverting input terminal (−) of the differential amplifier, and is also input from the non-inverting input terminal (+) through the capacitor 140AC and the amplitude adjustor 143A, and is subtracted by the differential amplifier, thereby reducing the influence of noise on the output signal output from the input/output circuit 144A. Noise entering from the alternating current signal source 142A is input to the non-inverting input terminal (+) through the amplitude adjustor 143A, and is also input from the non-inverting input terminal through the capacitor 140AC, and is subtracted by the differential amplifier 141A1, thereby reducing the influence of noise on the output signal output from the input/output circuit 144A.

### Charge Amplifier 141A

The charge amplifier 141A is a negative feedback amplifier and includes a differential amplifier 141A1 and a feedback circuit 141A2. The differential amplifier 141A1 is an example of a first differential amplifier, and the feedback circuit 141A2 is an example of a first feedback circuit.

The differential amplifier 141A1 includes a non-inverting input terminal (+) connected to the output terminal of the amplitude adjustor 143A, an inverting input terminal (−) connected to the first end portion 111 of the sensor electrode 110, and an output terminal connected to the input terminal of the multiplier 145A1. The inverting input terminal (−) of the differential amplifier 141A1 is an example of a first terminal, and the non-inverting input terminal (+) is an example of a second terminal.

The feedback circuit 141A2, which is a circuit in which a variable capacitor and a variable resistor are connected in parallel, is connected between the output terminal of the differential amplifier 141A1 and the inverting input terminal (−), and the phase of the output signal of the differential amplifier 141A1, the input signal of the inverting input terminal (−), and the amplification factor of the differential amplifier 141A1 are adjusted.

The charge amplifier 141A is a typical differential amplifier, and amplifies a difference between an input of the non-inverting input terminal (+) and an input of the inverting input terminal (−), and outputs a first output signal.

The charge amplifier 141A is also a typical negative feedback amplifier in which an output signal is fed back to the inverting input terminal (−). In this configuration, the circuit operates in such a manner that a current flowing from the sensor electrode 110 to the inverting input terminal (−) side of the differential amplifier 141A1 and a current fed back to the inverting input terminal (−) side from the output of the differential amplifier 141A1 (the output of the charge amplifier 141A) through the feedback circuit 141A2 become the same, so that the input current of the inverting input terminal (−) of the differential amplifier 141A1 becomes zero. Herein, the current fed back from the output of the differential amplifier 141A1 (the output of the charge amplifier 141A) to the inverting input terminal (−) side through the feedback circuit 141A2 is determined by the circuit constant of the feedback circuit. Then, by the circuit operating so that the input current at the inverting input terminal (−) of the differential amplifier 141A1 becomes zero, a voltage having substantially the same amplitude and phase as that of the shield electrode 120 is applied to the sensor electrode 110, in other words, the circuit operates to maintain an imaginary short condition.

### Amplitude Adjustor 143A

The amplitude adjustor 143A attenuates and outputs the alternating current signal supplied from the alternating current signal source 142A so that the output of the first real signal becomes zero in the case where the hand H is not present.

### Resistor R1

The resistor R1 represents the resistive component of the wire between the alternating current signal source 142A and the first end portion 121 of the shield electrode 120.

### Signal Processing Circuit 148A

### Multiplier 145A1

The multiplier 145A1 has one input terminal connected to the output terminal of the charge amplifier 141A, the other input terminal to which a sine wave is input, and an output terminal connected to the integrator 146A1. The sine wave that is input to the other input terminal is an alternating current signal as an example of a first alternating current signal, and its phase is adjusted so as to be the same as or in phase with the alternating current signal that is output from the alternating current signal source 142A. The multiplier 145A1 multiplies the output (first output signal) of the charge amplifier 141A by the alternating current signal as a sine wave, thereby extracting a signal component that is in phase with the alternating current signal source 142A from the output (first output signal) of the charge amplifier 141A and outputting the extracted signal to the integrator 146A1. The output (first output signal) of the charge amplifier 141A is determined by the signal of the alternating current signal source 142A and the impedance of a capacitive component or a resistor or the like connected to the inverting input terminal (−) of the charge amplifier 141A. The multiplier 145A1 multiplies the output of the charge amplifier 141A with a signal that is in phase with the alternating current signal source 142A. It is evident that, in the case where the amplitudes are identical but the phases differ, a different signal will be output when the output of the charge amplifier 141A is multiplied by a signal that is in phase with the alternating current signal source 142A. Although the final outcome ultimately follows results of calculation or simulation, generally speaking, a signal component that is in phase with the alternating current signal source 142A from which the first output signal is derived can be primarily extracted by the multiplier 145A1 performing multiplication with a signal in phase with the alternating current signal source 142A. This enables extraction of the signal corresponding to the capacitive component of the first output signal, and thus allowing the contact determination device 100 to detect primarily the capacitive component. The alternating current signal as a sine wave is an example of the first alternating current signal.

### Multiplier 145A2

The multiplier 145A2 has one input terminal connected to the output terminal of the charge amplifier 141A, the other input terminal to which a cosine wave is input, and an output terminal connected to the integrator 146A2. The cosine wave that is input to the other input terminal is an alternating current signal as an example of the second alternating current signal having a phase different by 90 degrees (phase advanced by 90 degrees) from that of the alternating current signal that is output from the alternating current signal source 142A, and the second alternating current signal is adjusted so as to have the phase different by 90 degrees (advanced by 90 degrees) from that of and the same amplitude as the alternating current signal that is output from the alternating current signal source 142A. The multiplier 145A2 multiplies the output (first output signal) of the charge amplifier 141A by the alternating current signal as a cosine wave, thereby extracting a signal component having a phase different by 90 degrees from that of the alternating current signal source 142A from the output (first output signal) of the charge amplifier 141A, and outputting the extracted signal to the integrator 146A2. As described above, the output (first output signal) of the charge amplifier 141A is determined by the signal of the alternating current signal source 142A and the impedance of a capacitive component or a resistor or the like connected to the inverting input terminal (−) of the charge amplifier 141A. The multiplier 145A2 multiplies the output of the charge amplifier 141A with a signal having a phase different by 90 degrees from that of the alternating current signal source 142A. It is evident that, in the case where the phases are identical but the amplitudes differ, a different signal will be output when the output of the charge amplifier 141A is multiplied by a signal having a phase different by 90 degrees from that of the alternating current signal source 142A. Although the final outcome ultimately follows results of calculation or simulation, generally speaking, a signal component having a phase different by 90 degrees from that of the alternating current signal source 142A from which the first output signal is derived can be primarily extracted by the multiplier 145A2 performing multiplication with a signal having a phase different by 90 degrees from that of the alternating current signal source 142A. This enables extraction of the signal corresponding to the resistive component of the first output signal, and thus allowing the contact determination device 100 to detect primarily the resistive component. Since a signal component having a phase different by 90 degrees from that of the alternating current signal source 142A of the first output signal is primarily extracted, the value tends to increase when the phase is shifted from that of the alternating current signal source 142A of the first output signal. The alternating current signal as a cosine wave is an example of a second alternating current signal.

### Integrator 146A1

The integrator 146A1 has an input terminal connected to the output terminal of the multiplier 145A1 and an output terminal connected to the input terminal of the ADC (analog-to-digital converter) 147A1, and outputs a signal obtained by integrating the output of the multiplier 145A1.

### Integrator 146A2

The integrator 146A2 has an input terminal connected to the output terminal of the multiplier 145A2 and an output terminal connected to the input terminal of the ADC (analog-to-digital converter) 147A2, and outputs a signal obtained by integrating the output of the multiplier 145A2.

### ADC 147A1

The ADC 147A1 has an input terminal connected to the output terminal of the integrator 146A1 and an output terminal connected to the electrostatic MCU 150, and receives the output signal of the integrator 146A1, converts the received signal into a corresponding digital value, and outputs the converted signal to the electrostatic MCU 150. Herein, since the signal is intended to extract a signal component in phase with the alternating current signal source 142A of the output (first output signal) of the charge amplifier 141A, the signal is hereinafter referred to as a “real signal”, specifically a “first real signal”. The first real signal is an example of the first conversion value. The signal is assumed to be a value corresponding to a capacitive component of the impedance of the contact determination apparatus 100, which is mainly detected by the detection circuit 140A.

### ADC 147A2

The ADC 147A2 has an input terminal connected to the output terminal of the integrator 146A2 and an output terminal connected to the electrostatic MCU 150, and receives the output signal of the integrator 146A2, converts the received signal into a corresponding digital value, and outputs the converted signal to the electrostatic MCU 150. Herein, since the signal is intended to extract a signal component having a phase different by 90 degrees from that of the alternating current signal source 142A of the output (first output signal) of the charge amplifier 141A, the signal is hereinafter referred to as an “imaginary signal”, specifically a “first imaginary signal”. The first imaginary signal is an example of the second conversion value. The signal is assumed to be a value corresponding to a resistive component of the impedance of the contact determination apparatus 100, which is mainly detected by the detection circuit 140A.

In the present specification, the terms “real signal” and “imaginary signal” are used solely for convenience to denote signal components whose phases differ by 90 degrees, and the assignment of these terms may be interchanged without loss of generality.

The first real signal and the first imaginary signal are input to the electrostatic MCU 150. Hereinafter, the first real signal and the first imaginary signal are collectively referred to as the “first detection signal Sens1”.

### Circuit Configuration of Detection Circuit 140B

Since the circuit configuration of the detection circuit 140B is the same as that of the detection circuit 140A, a difference from that of the detection circuit 140A will be described here.

The main difference is a connection relationship, in which the input/output circuit 144A of the detection circuit 140A is connected to the first end portion 111 of the sensor electrode 110 and the first end portion 121 of the shield electrode 120, while the input/output circuit 144B of the detection circuit 140B is connected to the second end portion 112 of the sensor electrode 110 and the second end portion 122 of the shield electrode 120.

### Input/Output Circuit 144B

### Capacitor 140BC

A capacitor 140BC corresponds to the capacitor 140AC and is arranged differently. The capacitor 140BC is connected between the second end portion 112 of the sensor electrode 110 and the second end portion 122 of the shield electrode 120.

### Charge Amplifier 141B

A charge amplifier 141B corresponds to the charge amplifier 141A, a differential amplifier 141B1 corresponds to the differential amplifier 141A1, and a feedback circuit 141B2 corresponds to the feedback circuit 141A2 and is arranged differently. A differential amplifier 141B1 is an example of a second differential amplifier, and feedback circuit 141B2 is an example of a second feedback circuit.

The differential amplifier 141B1 has a non-inverting input terminal (+) connected to the output terminal of the amplitude adjustor 143B, an inverting input terminal (−) connected to the second end portion 112 of the sensor electrode 110, and an output terminal connected to the input terminal of the multiplier 145B1. The inverting input terminal (−) of the differential amplifier 141B1 is an example of a third terminal, and the non-inverting input terminal (+) is an example of a fourth terminal. The charge amplifier 141B outputs a second output signal.

### Amplitude Adjustor 143B

The amplitude adjustor 143B corresponds to the amplitude adjustor 143A and is arranged differently. The input terminal of the amplitude adjustor 143B is connected to the drive circuit 142. Therefore, an alternating current signal of a positive potential output from the drive circuit 142 is supplied to the input terminal of the amplitude adjustor 143B.

### Resistor R1

The resistor R1 represents the resistive component of the wire between the alternating current signal source 142A and the second end portion 122 of the shield electrode 120.

### Signal Processing Circuit 148B

### Multiplier 145B1

The multiplier 145B1 corresponds to the multiplier 145A1. The multiplier 145B1 has one input terminal connected to the output terminal of the charge amplifier 141B, the other input terminal to which a sine wave is input, and an output terminal connected to the integrator 146B1. The sine wave that is input to the other input terminal is an alternating current signal as an example of first alternating current signal, and its phase is adjusted so as to be the same as or in phase with the alternating current signal that is output from the alternating current signal source 142A.

### Multiplier 145B2

The multiplier 145B2 corresponds to the multiplier 145A2. The multiplier 145B2 has one input terminal connected to the output terminal of the charge amplifier 141B, the other input terminal to which a cosine wave is input, and an output terminal connected to the integrator 146B2. The cosine wave that is input to the other input terminal is an alternating current signal as an example of a second alternating current signal having a phase different by 90 degrees (phase advanced by 90 degrees) from that of the alternating current signal that is output from the alternating current signal source 142A, and the second alternating current signal is adjusted so as to have the phase different by 90 degrees (advanced by 90 degrees) from that of and the same amplitude as the alternating current signal that is output from the alternating current signal source 142A.

### Integrator 146B1

The integrator 146B1 corresponds to the integrator 146A1. The integrator 146B1 has an input terminal connected to the output terminal of multiplier 145B1 and an output terminal connected to the input terminal of ADC (analog-to-digital converter) 147B1.

### Integrator 146B2

The integrator 146B2 corresponds to the integrator 146A2. The integrator 146B2 has an input terminal connected to the output terminal of the multiplier 145B2 and an output terminal connected to the input terminal of the ADC (analog-to-digital converter) 147B2.

### ADC 147B1

An ADC 147B1 corresponds to the ADC 147A1. The ADC 147B1 has an input terminal connected to the output terminal of the integrator 146B1 and an output terminal connected to the electrostatic MCU 150, and receives the output signal of the integrator 146B1, converts the received signal into a corresponding digital value, and outputs the converted signal to the electrostatic MCU 150. Herein, this signal is mainly intended to extract a signal component in phase with the alternating current signal source 142A and the alternating current signal source 142A, and is therefore hereinafter referred to as a “real signal”, specifically a “second real signal”. The second real signal is an example of the third conversion value.

### ADC 147B2

The ADC 147B2 has an input terminal connected to the output terminal of the integrator 146B2 and an output terminal connected to the electrostatic MCU 150, and receives the output signal of the integrator 146B2, converts the received signal into a corresponding digital value, and outputs the converted signal to the electrostatic MCU 150. Herein, this signal is mainly intended to extract a signal component having a phase different by 90 degrees from that of the alternating current signal source 142A, and is therefore hereinafter referred to as an “imaginary signal”, specifically a “second imaginary signal”. The second imaginary signal is an example of a fourth conversion value.

The second real signal and the second imaginary signal are input to the electrostatic MCU 150. Hereinafter, the second real signal and the second imaginary signal are collectively referred to as a “second detection signal Sens2”.

### Determiner 151

The determiner 151 illustrated in FIG. 1 determines the presence or absence of an abnormality in the sensor electrode 110 based on a first output signal that is output from the wire A1 (first wire) and a second output signal that is output from the wire A2 (second wire), and determines whether the detection target is in contact with the surface layer 11A or not based on the first output signal or the second output signal.

More specifically, when determining whether the hand H is in contact with the rim 11, the determiner 151 determines whether the signal value of the first real signal or the second real signal is equal to or greater than a contact determination threshold. The determiner 151 determines that the hand H is in contact with the rim 11 if the signal value of the first real signal or the second real signal is equal to or greater than the contact determination threshold, and determines that the hand H is not in contact with the rim 11 if the signal values of the first real signal and the second real signal are less than the contact determination threshold.

When the determiner 151 determines the presence or absence of an abnormality in the sensor electrode 110, the determiner 151 determines the difference between the first real signal and the second real signal and the difference between the first imaginary signal and the second imaginary signal, and determines the presence or absence of an abnormality in the sensor electrode 110 based on these values. Details of the determination processing by the determiner 151 will be described later.

### Description of Operation of Detection Circuit 140A

Next, specific operation of the circuit will be described. First, the detection circuit 140A will be described.

### Equivalent Circuit When Sensor Electrode 110 Operates Normally

An equivalent circuit when the sensor electrode 110 is operating normally will be described with reference to FIG. 2B.

The shield electrode 120 and the sensor electrode 110 can be simply regarded as conductors. As illustrated in FIG. 2A, the alternating current signal source 142A is connected to the inverting input terminal (−) of the differential amplifier circuit via the shield electrode 120, the capacitance Crs, and the sensor electrode 110. The capacitances Crgl and Chg are connected in parallel between the sensor electrode 110 and the ground. In the wire and related components, there exists a resistive component R1 that cannot be neglected when determining the input signal at the inverting (−) terminal of the differential amplifier. The capacitor 140AC is used to pass EMC noise in the several-MHz frequency range, and the capacitor 140AC presents a high impedance to the several-kHz frequency-band signal from the alternating current signal source 142A. In other words, the capacitor 140AC can be regarded as an insulator, and therefore can be neglected when determining the input signal at the inverting (−) terminal of the differential amplifier circuit. Given that the capacitance Csg is also connected between the shield electrode 120 and the ground and has a constant value, the capacitance Csg is connected to the connection circuits of Crs, Chgl, and Csg in parallel, which affect obtaining the input signal of the inverting input terminal (−) and has a constant value. Therefore, the capacitance Csg can be ignored for obtaining the input signal of the inverting input terminal (−) of the differential amplifier circuit.

Therefore, the equivalent circuit from the alternating current signal source 142A to the differential amplifier 141A1 until generating the first output signal can be represented by the circuit illustrated in FIG. 2B, and the voltage obtained by dividing the voltage of the drive circuit 142 is input to the inverting input terminal (−) of the differential amplifier.

### Waveform When Sensor Electrode 110 Operates Normally

### Explanation of Waveform

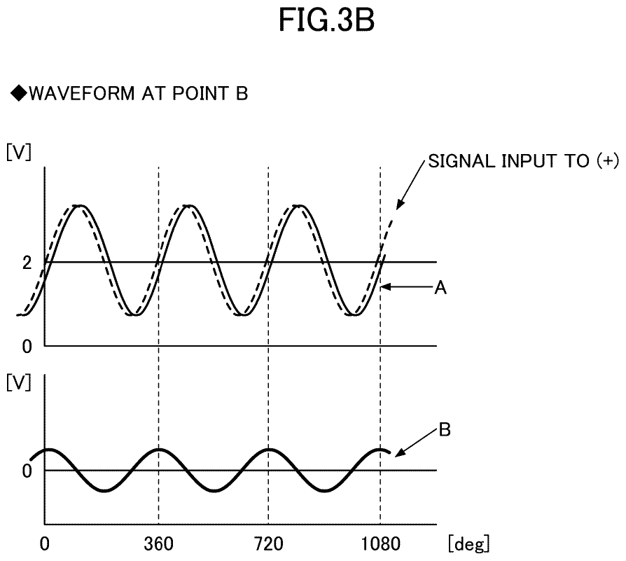

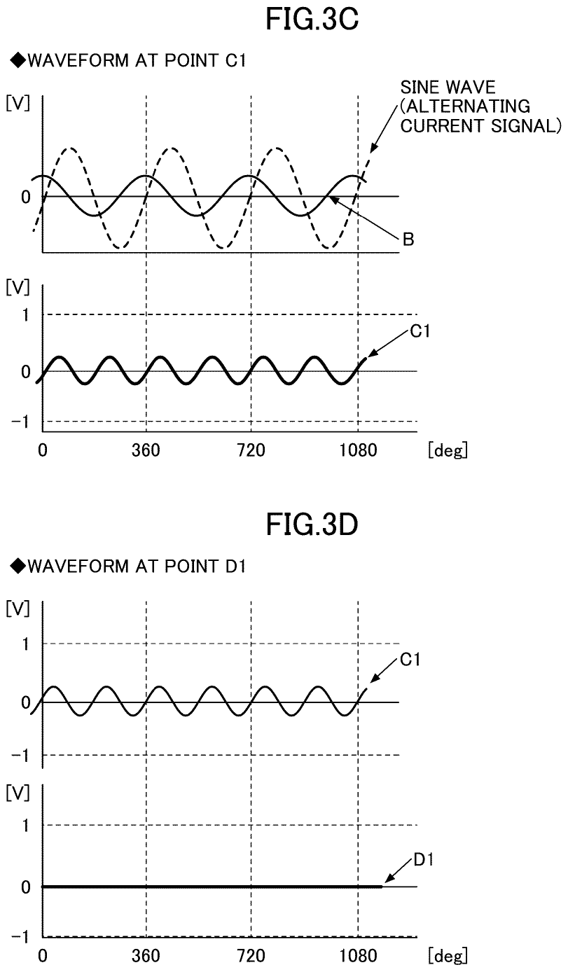

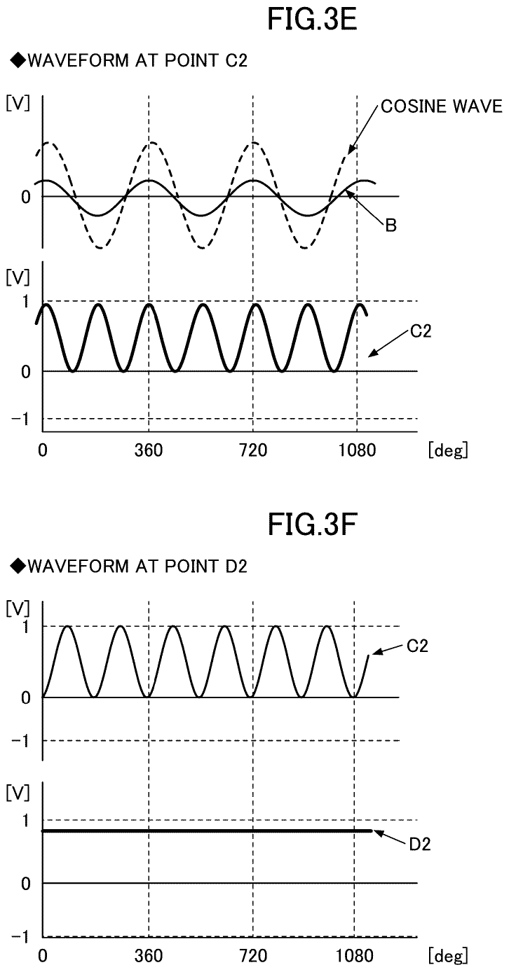

Next, the result of simulation performed using the equivalent circuit of FIG. 2B for the signal waveform at different positions indicated by the points in FIG. 2A will be described with reference to FIG. 3A, etc. The horizontal axis represents the phase, and the vertical axis represents the voltage. For readability, the voltage scale on the vertical axis does not necessarily match across all graphs. However, at each corresponding point, the voltage scale on the vertical axis is shown consistently. In the present specification, unless otherwise described, a non-proximity state and a proximity state refer to the conditions in which the sensor electrode 110 is operating normally, and in the case where a breakage has occurred or a crack has formed in the electrode, the state is the non-proximity state.

### Non-Proximity State

The non-proximate state of the hand H when the sensor electrode 110 is operating normally is a state in which Chg is set to zero (the same state in which Chg is not connected) in the equivalent circuit of FIG. 2B, and the waveform of point A of FIG. 2A (the input signal of the inverting input terminal of the differential amplifier 141A1) is a signal in which the waveform is attenuated or the phase is delayed as compared with the waveform of the output signal of the drive circuit 142 (shown by the broken line), as shown in FIG. 3A. The attenuation and the phase delay are caused by the presence of the resistor R1 in the wire or the like in an actual circuit.

The signal that is output from the amplitude adjustor 143A and input to the non-inverting input terminal (+) of the differential amplifier 141A1 has the same 2 V voltage of the direct current signal source 142D of the drive circuit 142 and includes an alternating current signal whose amplitude from thee alternating current signal source 142A has been adjusted. This adjustment is performed in such a manner that the amplitude of signal B, described later, is minimized as much as possible. Since the signal that is input to (+) is in phase with the output signal of the drive circuit 142, the signal is out of phase with signal A, and intersects signal A near the vertices, that is, around 90 degrees and 270 degrees corresponding to the maximum value and the minimum value (see the upper graph of FIG. 3B). Therefore, the differential signal B of the differential amplifier 141A1 becomes zero near around 90 degrees and 270 degrees as shown in the lower graph of FIG. 3B, and a signal out of phase with the waveform of the drive circuit 142 by 90 degrees is output.

Next, the multiplier 145A1 multiplies the output signal B of the differential amplifier circuit by a voltage (sine wave) having the same phase and the same amplitude as the alternating current signal source 142A of the drive circuit 142, that is, signal B is multiplied by a signal out of phase by 90 degrees, and outputs a signal C1 shown in FIG. 3C from the output of the multiplier 145A1 (point C1 of FIG. 2A). Signal C1 becomes a sine wave centered at the voltage 0 [V].

Next, the output signal of the multiplier 145A1 is integrated, and an output signal D1 shown in FIG. 3D is output from the output terminal of the integrator 146A1 (point D1 of FIG. 2A). Signal D1 is the voltage 0 [V].

Next, the ADC 147A1 outputs an AD value corresponding to the signal of the integrator 146A1. The AD value in the state where the hand H is not in proximity becomes zero, and the first real signal becomes zero.

Next, the output signal of the output of the multiplier 145A2 (point C2 in FIG. 2A) will be described with reference to FIG. 3E. The multiplier 145A2 multiplies the output signal of the differential amplifier circuit by a voltage (cosine wave) that is out of phase with the alternating current signal source 142A by 90 degrees, that is, a signal in phase with signal B is multiplied, and outputs a signal C2 shown in FIG. 3E from the output of the multiplier 145A2 (point C2 in FIG. 2A). In other words, since the output signal B is multiplied by a signal in phase with the signal at point C, the signal at point C2 is output as a sine wave whose values are non-negative.

Next, the integrator 146A2 integrates the output signal of the multiplier 145A2, and outputs signal D2 shown in FIG. 3F.

Next, the ADC 147A2 outputs an AD value corresponding to the signal of the integrator 146A2. The AD value in the state where the hand is not in proximity is a predetermined value, and the value of the first imaginary signal is 0.85, for example.

The 2 V voltage from the direct current signal source 142D is added at point B in order to ensure that the signal waveform falls within the operating voltage range of a typical IC; however, depending on the IC used, this is not necessarily required. Although a sine wave centered at 0 V is used at point B, a predetermined direct current voltage may be added so that the voltage is always 0 V or greater. In the case where the predetermined direct current voltage is added, the value may be set in consideration of the portion or the calculation may be performed by subtracting the portion in the subsequent signal processing, if necessary. The same applies to the description hereinafter.

### Proximity State

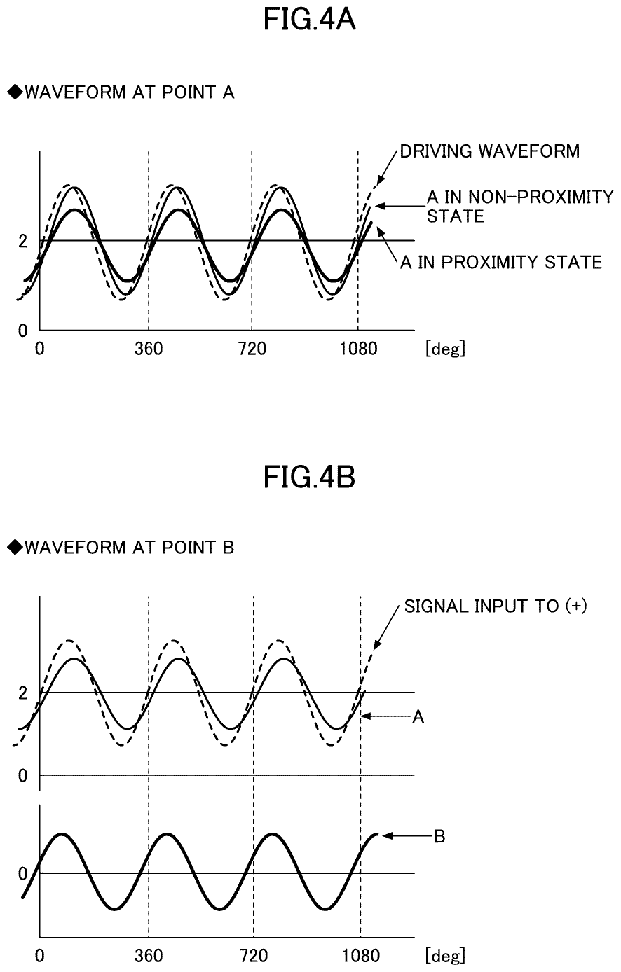

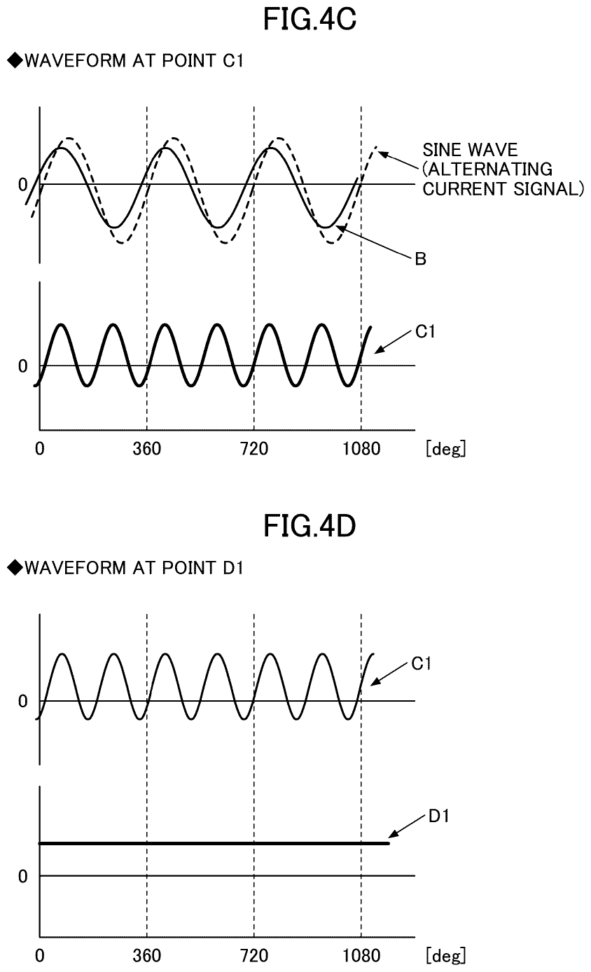

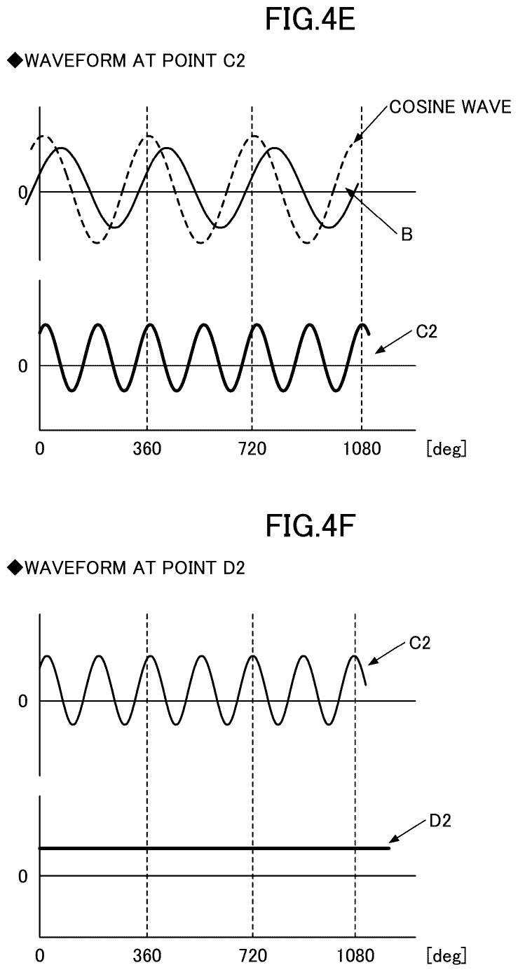

Next, the waveform observed when the sensor electrode 110 is operating normally and a hand is in proximity will be described. This state can be represented by the equivalent circuit illustrated in FIG. 2B, and a waveform simulated using this circuit is observed. As shown in FIG. 4A, the waveform at point A (the input signal at the inverting input terminal of the differential amplifier 141A1) of FIG. 2A becomes a signal attenuated and advanced in phase compared with the driving waveform.

Then, the output signal of the amplitude adjustor is input to the non-inverting input terminal (+) of the differential amplifier circuit, the signal at point A is input to the inverting input terminal (−), and at point B, the differential amplifier 141A1 outputs a differential signal B as shown in FIG. 4B. The differential signal B becomes a signal having a larger amplitude compared with the proximity state and advanced in phase compared with the non-proximity state.

Next, the multiplier 145A1 multiplies the output signal of the differential amplifier circuit by a voltage in phase with that of the alternating current signal source 142A of the drive circuit 142, and outputs signal C1 shown in FIG. 4C from the output of the multiplier 145A1 (point C1 of FIG. 2A).

Next, the integrator 146A1 integrates the output signal of the multiplier 145A1, and outputs signal D1 shown in FIG. 4D at point D1.

Next, the ADC 147A1 outputs an AD value corresponding to the signal of the integrator 146A1. In the state where the hand H is in proximity, the AD value becomes a predetermined value, and the first real signal becomes, for example, a value of 0.9.

Next, an output signal of the output of the multiplier 145A2 (point C in FIG. 2A) will be described. The multiplier 145A2 multiplies the output signal of the differential amplifier circuit by a voltage out of phase by 90 degrees with the alternating current signal source 142A of the drive circuit 142, and outputs a signal C2 shown in FIG. 4E from the output of the multiplier 145A2 (point C2 in FIG. 2A).

Next, the integrator 146A2 integrates the output signal of the multiplier 145A2, and outputs signal D2 shown in FIG. 4F.

Next, the ADC 147A2 outputs a predetermined AD value, for example, 0.6, corresponding to the signal of the integrator 146A2.

### When Electrode Is Broken

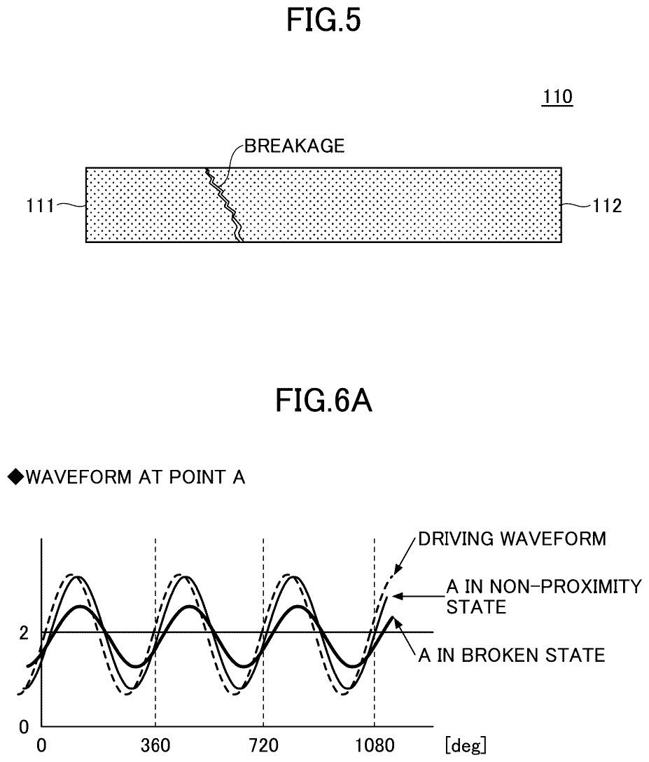

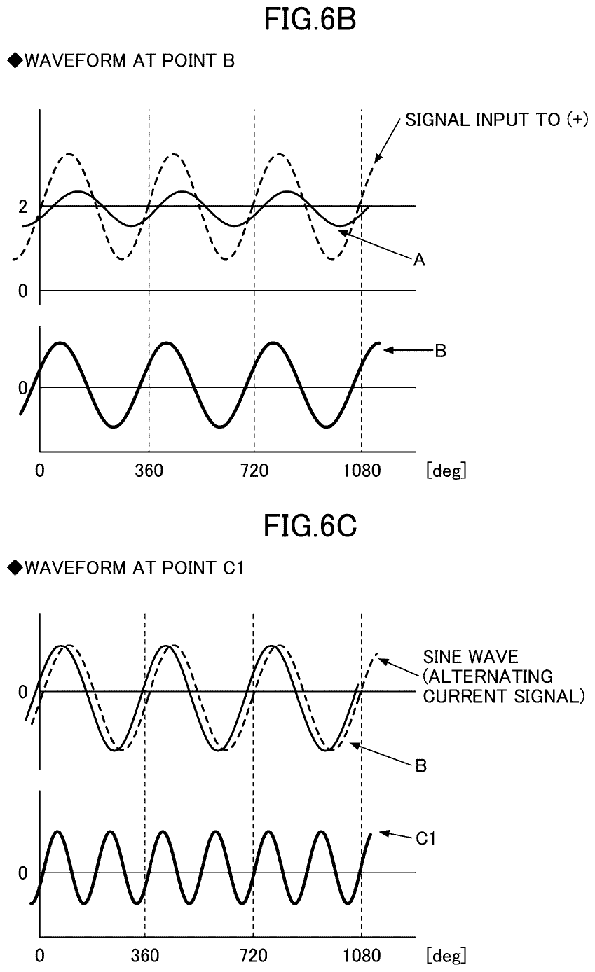

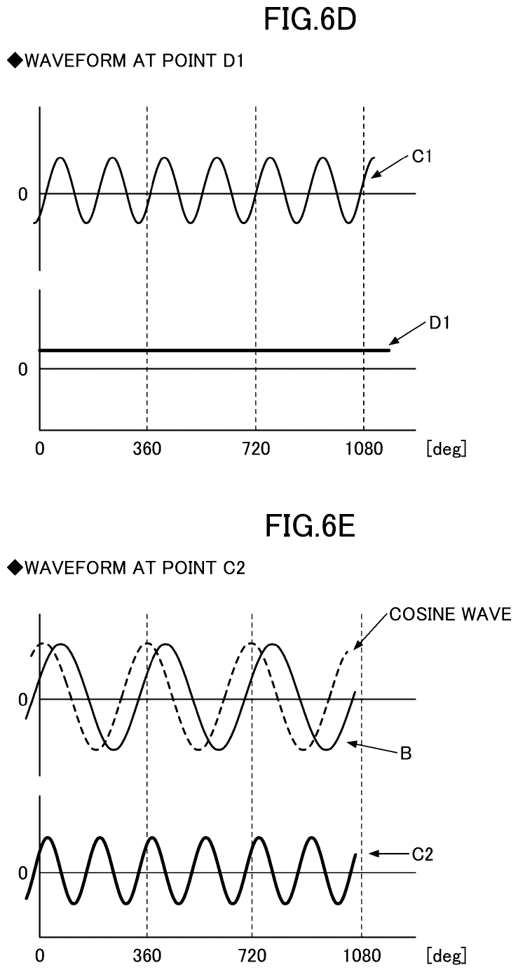

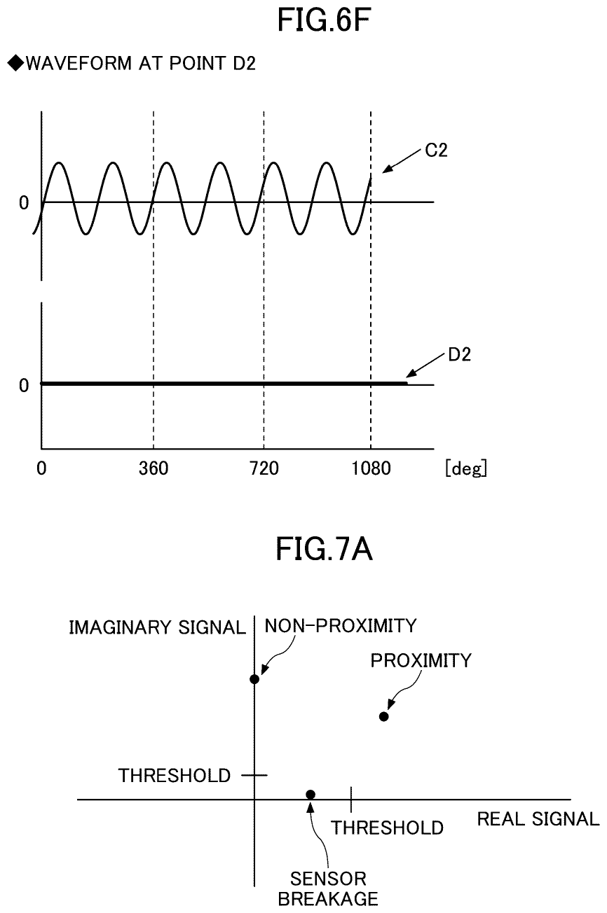

Next, as illustrated in FIG. 5, a description will be given of a state in which the sensor electrode 110 is broken at the of the first end portion 101 side. The equivalent circuit after the breakage has occurred is the equivalent circuit illustrated in FIG. 2B, and the value of Crs is set to be less than ½Crs. In the state in which the hand H is not in proximity, Chg may be set to zero, and the waveform at point A becomes the waveform shown in FIG. 6A by simulation. In this state, the electrode not connected to the input/output circuit 144A or 144B among the broken electrodes is missing. Therefore, the capacitance value Crs decreases in the state in which the hand is not in proximity, and the waveform shown in FIG. 6A is observed.

The waveform at point B shown in FIG. 6B is observed.

The waveform at point C1 shown in FIG. 6C is observed.

The waveform at point D1 shown in FIG. 6D is observed.

Next, the ADC 147A1 outputs a predetermined AD value corresponding to the signal of the integrator 146A1, for example, 0.4.

The waveform at point C2 shown in FIG. 6E is observed.

The waveform at point D2 shown in FIG. 6F is observed.

Next, the ADC 147A2 outputs a predetermined AD value corresponding to the signal of the integrator 146A2, that is, 0.05.

### Determination Only by Detection Circuit 140A

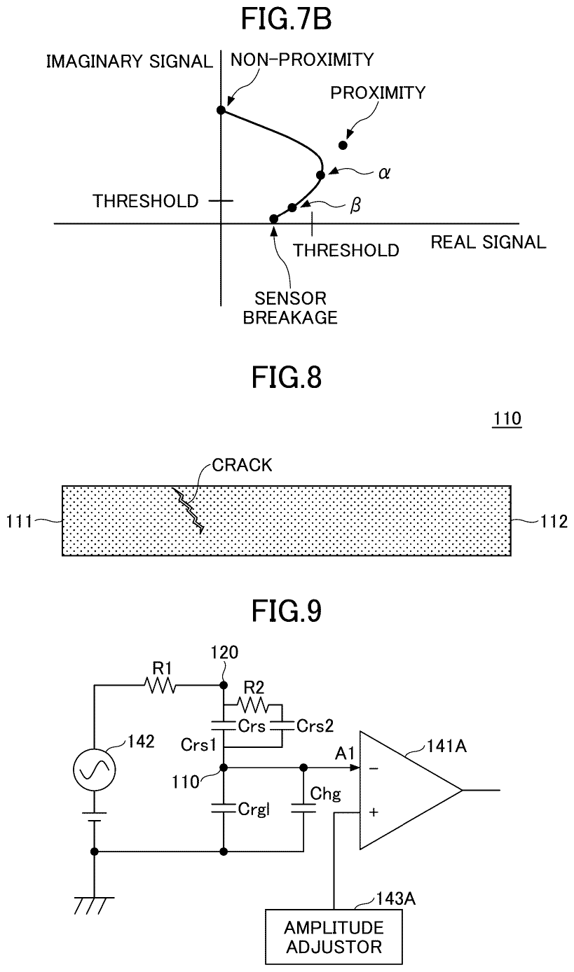

Determination by the detection circuit 140A only will be described below for comparison with the present invention. FIG. 7A is a diagram illustrating the result of the above embodiment on a plane of a real signal and an imaginary signal.

In the comparative example, whether or not a hand is in proximity is determined by the first real signal, and whether or not the electrode is broken is determined by the first imaginary signal. Specifically, when the first real signal meets or exceeds a predetermined threshold, it is determined that a hand is in contact with the steering rim, and when the first imaginary signal is equal to or less than the predetermined value, it is determined that the electrode is broken.

### When Crack Has Formed in Sensor Electrode 110

In the comparative example, it was found that the sensor electrode 110 exhibits characteristics as illustrated in FIG. 7B before being broken as described above, and that there exists a region where it is difficult to determine that the hand is in contact with the steering rim, and this will be described below.

### Equivalent Circuit When Crack has Formed in Sensor Electrode 110

FIG. 8 is a diagram illustrating an example of a state in which a crack has formed in the sensor electrode 110, and illustrates a state before the sensor electrode 110 illustrated in FIG. 5 is fully broken. The sensor electrode 110 is a band-like electrode, and when a crack as illustrated in FIG. 8 forms, the resistance value between the first end portion 111 and the second end portion 112 increases to a level that cannot be neglected as compared with a case in which no crack has formed. The sensor electrode 110 is divided into a plurality of portions by the crack, and each portion capacitively couples with the shield electrode 120. Therefore, the equivalent circuit from the alternating current signal source 142A to the differential amplifier 141A1 in a state in which a crack has formed in the sensor electrode 110 is a circuit illustrated in FIG. 9. The case in which one crack has formed will be described, but the description is applicable to the case in which a plurality of cracks have formed.

### Explanation of Waveforms

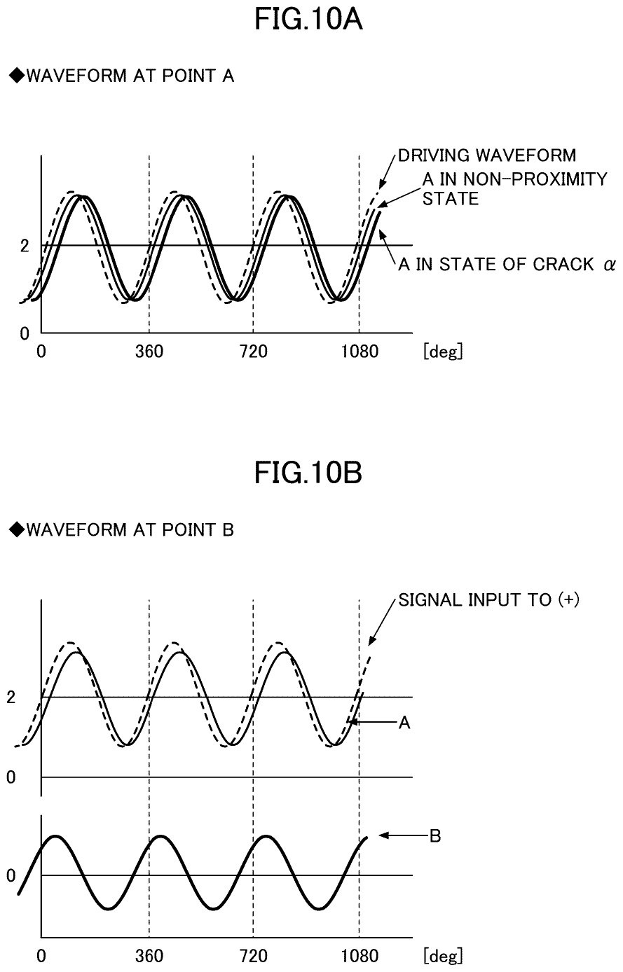

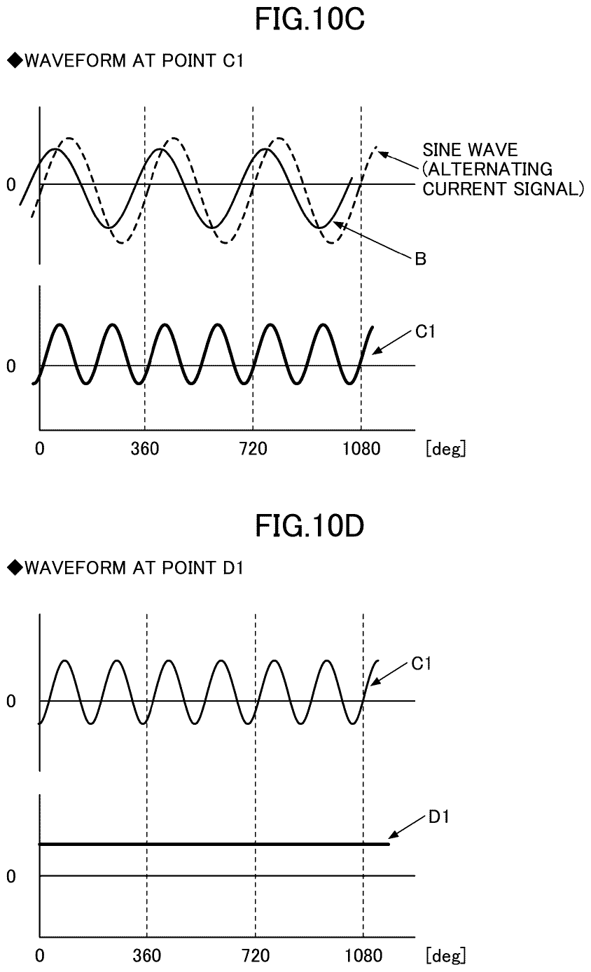

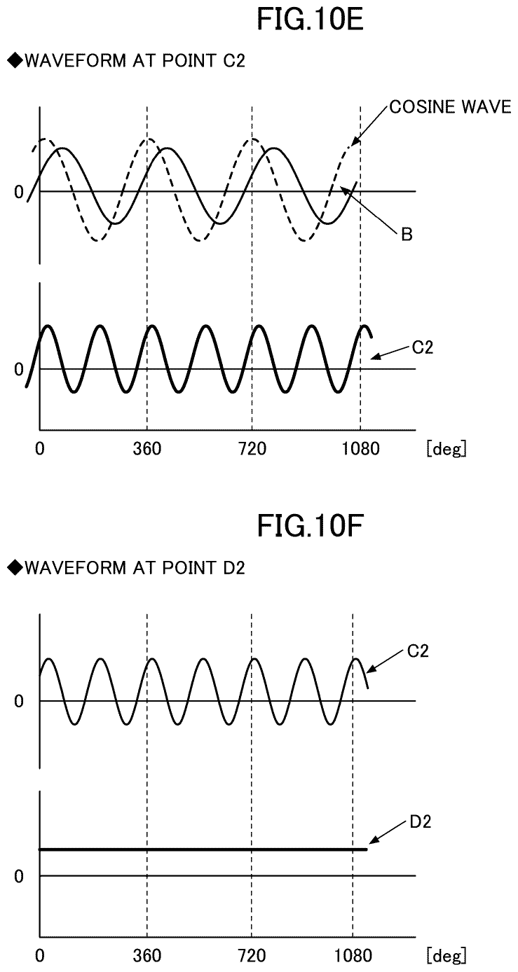

Hereinafter, the results of simulation of waveforms in a state in which a small crack has formed using the equivalent circuit described above are described with reference to FIGS. 10A through 10F. A small crack means that the length of the crack illustrated in FIG. 8 is short. FIGS. 10A through 10F are graphs showing examples of waveforms obtained by simulation in the equivalent circuit illustrated in FIG. 9 in a state where a small crack has formed.

The waveform at point A is as shown in FIG. 10A, and the amplitude and phase change as compared with the non-proximity state.

The waveform at point B1 shown in FIG. 10B is observed.

The waveform at point C1 shown in FIG. 10C is observed.

The waveform at point D1 shown in FIG. 10D is observed.

Then, the ADC 147A1 outputs a predetermined AD value, for example, 0.7, corresponding to the signal of the integrator 146A1.

The waveform at point C2 shown in FIG. 10E is observed.

The waveform at point D2 shown in FIG. 10F is observed.

Then, the ADC 147A2 outputs a predetermined AD value, for example, 0.4, corresponding to the signal of the integrator 146A2. The values of the real part and the imaginary part that are output in the state where a small crack (see FIG. 8) has formed as described above are the values corresponding to point α in FIG. 7B.

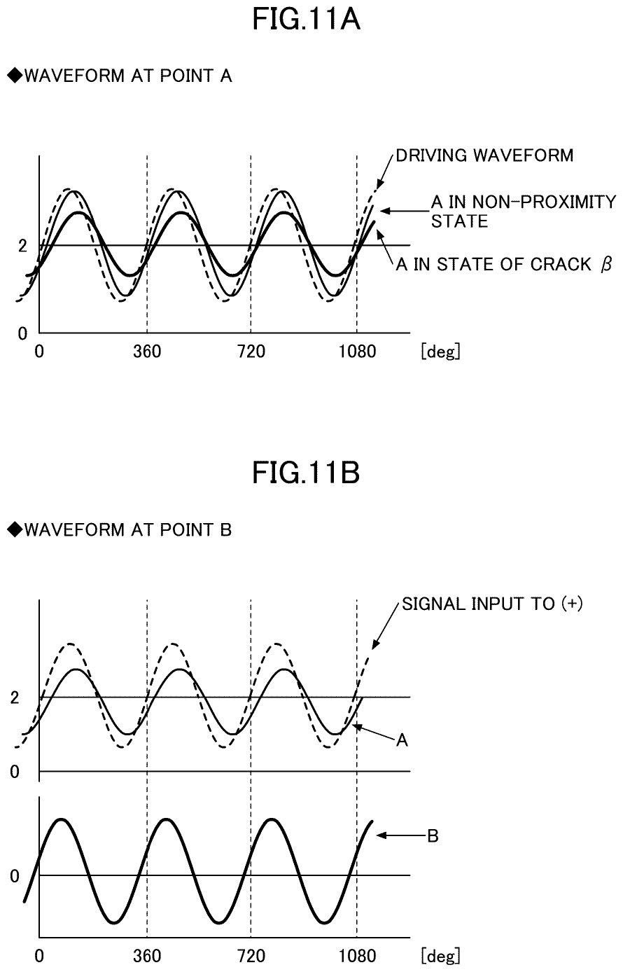

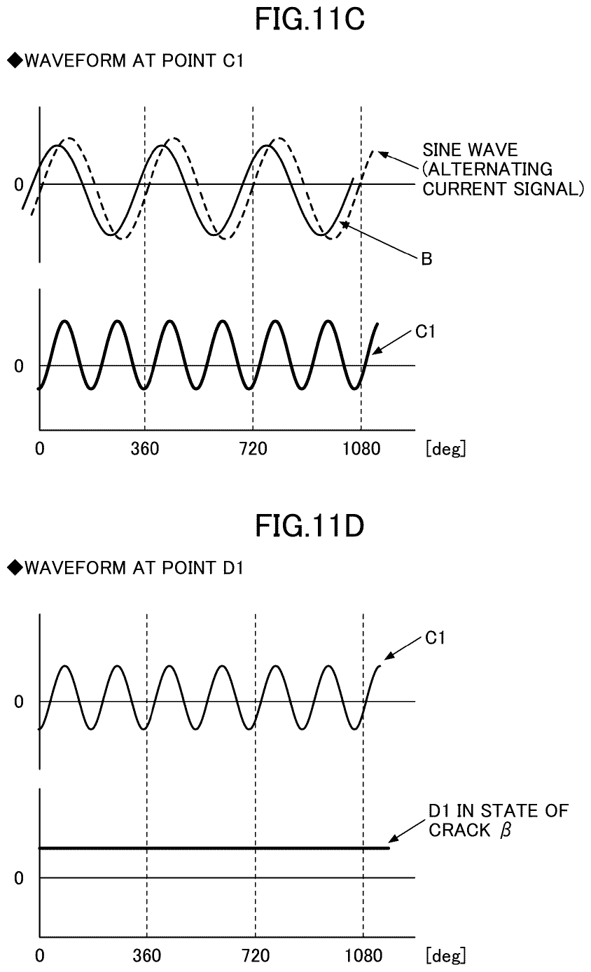

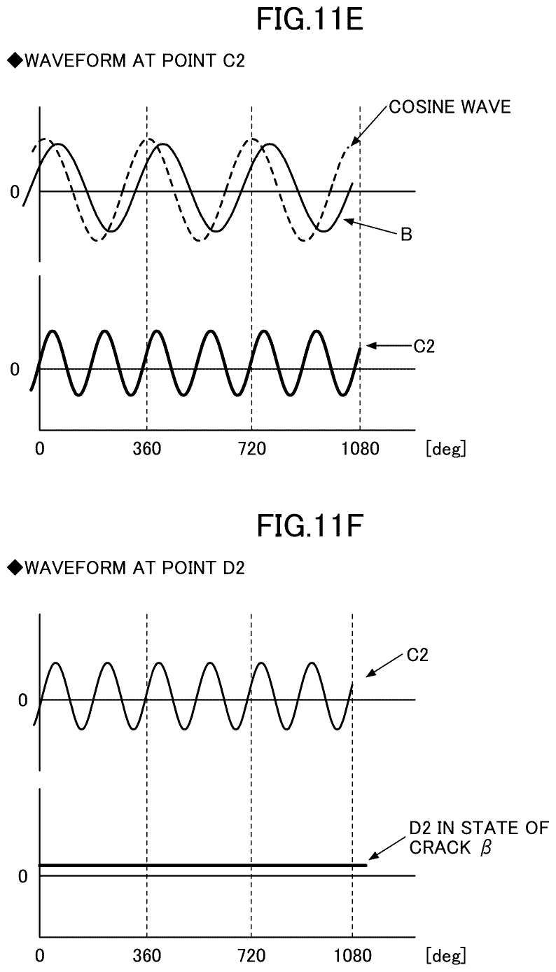

Next, the results of simulation of the waveform in the state where a large crack has formed using the equivalent circuit described above will be described with reference to FIGS. 11A through 11F. A large crack means that the length of the crack illustrated in FIG. 8 is long. FIGS. 11A through 11F are graphs showing examples of waveforms obtained by simulation in the equivalent circuit illustrated in FIG. 9 in a state where a large crack has formed.

The waveform at point A is as shown in FIG. 11A, and the amplitude and phase change as compared with the non-proximity state.

The waveform at point B shown in FIG. 11B is observed.

The waveform at point C1 shown in FIG. 11C is observed.

The waveform at point D1 shown in FIG. 11D is observed.

Then, the ADC 147A1 outputs a predetermined AD value, for example, 0.5, corresponding to the signal of the integrator 146A1.

The waveform at point C2 shown in FIG. 11E is observed.

The waveform at point D2 shown in FIG. 11F is observed.

Then, the ADC 147A2 outputs a predetermined AD value, for example, 0.15, corresponding to the signal of the integrator 146A2. The values of the real part and the imaginary part that are output in the state where a large crack has formed as described above are the values corresponding to point β in FIG. 7B.

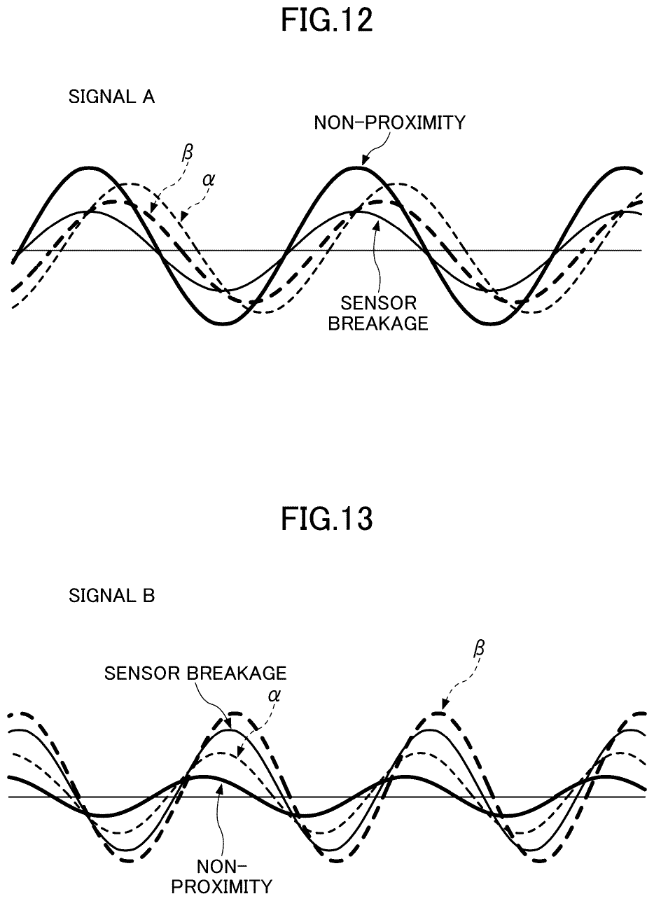

Signal A at point A exhibits the exaggerated waveform shown in FIG. 12. The amplitude is largest in the non-proximity state and decreases in the following order: small crack (α), large crack (β), and breakage. The phase advances significantly when a small crack occurs compared with the non-proximity state, and lags when a large crack or a breakage occurs.

FIG. 13 is a diagram illustrating the exaggerated waveform of signal B at point B, which is a signal of difference between signal A at point A and the attenuation signal. As illustrated in FIG. 13, the amplitude is smallest in the non-proximity state, and increases in the following order: small crack (α), sensor breakage, and large crack (β). The real part of the graph depicted in FIG. 7B is the smallest in the non-proximity state, and increases in the following order: sensor breakage, large crack (β), and small crack (α). Therefore, the real part of the graph depicted in FIG. 7B generally exhibits a tendency similar to that of the amplitude of signal B, although the position (order) of small crack (α) differs. As described above, the multiplier 145A1 extracts a signal component that is in phase with the alternating current signal source 142A by multiplying signal B by a signal in phase with the alternating current signal source 142A from which signal B is derived. It has been confirmed that the real part (i.e., the value calculated by the multiplier 145A1 by multiplying signal B by the signal in phase with the alternating current signal source 142A) roughly corresponds to the amplitude of output signal B from the differential amplifier 141A1.

The phase of signal B increases relative to the non-proximity state in the order of a small crack (α), a sensor breakage, and a large crack (β). The imaginary part of the graph depicted in FIG. 7B decreases relative to the non-proximity state in the order of a crack small (α), a crack large (β), and a sensor breakage. Therefore, the imaginary part of the graph depicted in FIG. 7B generally exhibits a tendency similar to that of the phase of signal B, although the position (order) of a sensor breakage and a crack large (β) are reversed. As described above, the multiplier 145A2 extracts a signal component having a phase different by 90 degrees from that of the alternating current signal source 142A by multiplying signal B by a signal having a phase different by 90 degrees from that of the alternating current signal source 142A from which signal B is derived, and the value tends to increase when the phase is shifted from that of the alternating current signal source 142A. It has been confirmed that the imaginary part (the value calculated by the multiplier 145A2 by multiplying signal B by the signal having a phase different by 90 degrees from that of the alternating current signal source 142A by 90 degrees) roughly corresponds to the phase of output signal B from the differential amplifier 141A1.

The graph depicted in FIG. 7B is obtained by connecting AD values calculated by substituting a plurality of values from 0 to infinity for the resistor R2 and performing simulations for each value. The resistor R2 represents a resistive component of the sensor electrode 110, and is a value regarded as zero in the initial state, but increases with an occurrence of a crack, and becomes a value regarded as infinity when the sensor electrode 110 is fully broken.

As described above, a region was observed in which the AD values became approximately equal in both the proximity state and the state where a crack has formed in the sensor electrode 110. Next, the general reason for this is described below based on the equivalent circuit of FIG. 9.

As is apparent from the equivalent circuit of FIG. 9, signal A roughly corresponds to the ratio of the impedance of the parallel circuits of Crgl and Chg to the impedance of Crs. When the hand H is in proximity, Chg increases, so that the capacitance of the parallel circuits of Crgl and Chg increases (the impedance decreases), while the impedance of Crs does not change. Therefore, the ratio of the impedance of the parallel circuits of Crgl and Chg to the impedance of Crs increases, so that signal A1 decreases. When a crack has formed, the current flows into the resistor R2 and the current flowing into Crs2 decreases, so that the apparent capacitance value of Crs2 decreases. At this time, the impedance of the parallel circuits of Crgl and Chg does not change. Therefore, as in the proximity state, the ratio of the impedance of the parallel circuits of Crgl and Chg to the apparent impedance of Crs increases, so that signal A1 decreases. As described above, when a crack has formed, the output trend is similar to that when the hand H is in proximity.

### Description of Operation of Detection Circuit 140B

Next, the operation of the detection circuit 140B will be described. In the non-proximity state and the proximity state when the sensor electrode 110 is operating normally, the equivalent circuit from the alternating current signal source 142A to the differential amplifier 141B1 of detection circuit 140B is equivalent to the equivalent circuit from the alternating current signal source 142A to the differential amplifier 141A1 illustrated in FIG. 2B, and the operation is also equivalent. Therefore, the operation of the detection circuit 140B is also equivalent to the operation of the detection circuit 140A, and a detailed description thereof will be omitted.

### When Electrode Is Broken

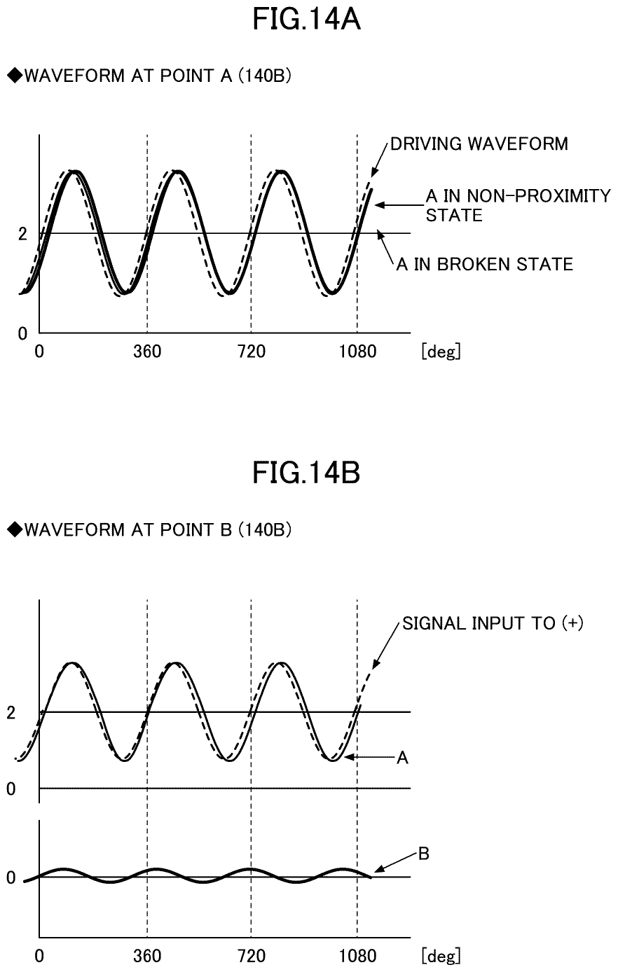

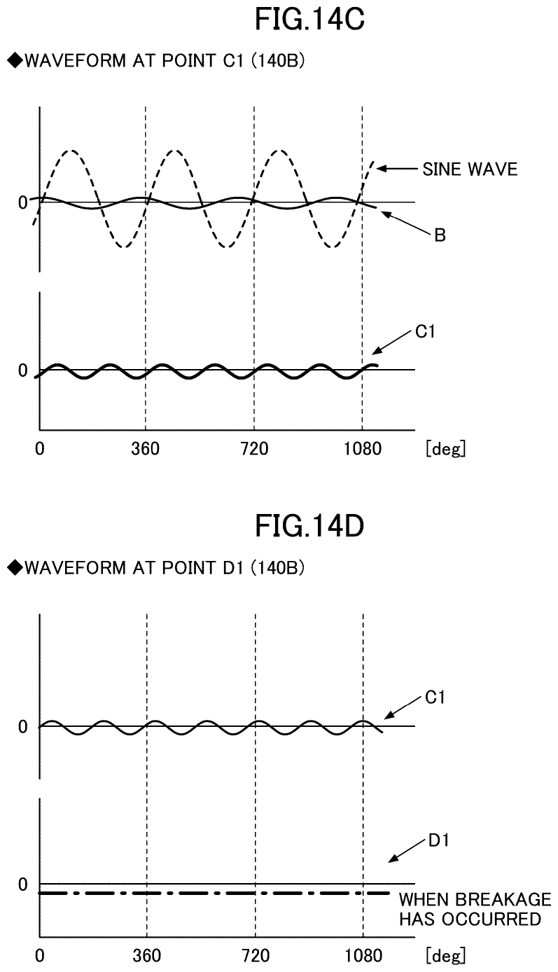

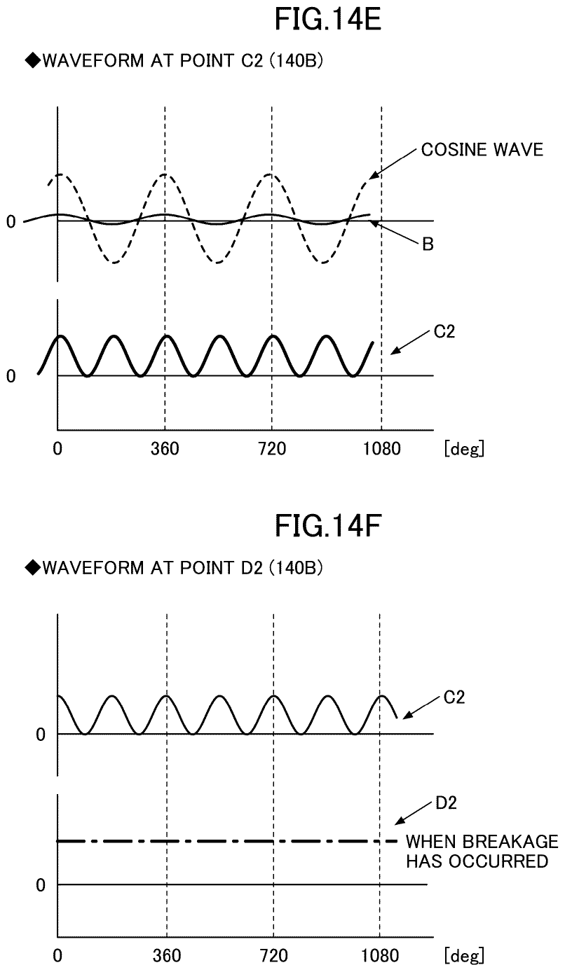

FIGS. 14A through 14F show the results of calculating the waveform by simulation in a state in which the sensor electrode 110 is broken at the first end portion 101 side as illustrated in FIG. 5, in other words, in a state in which the electrode in the second end portion side is larger than ½ of the initial area.

FIG. 14A shows the output waveform at point A of the detection circuit 140B. At the output at point A, the phase is the same as the phase at point A of the detection circuit 140A, but the amplitude is larger than in the non-proximity state for reasons described in detail below.

FIG. 14B shows the output waveform at point B of the detection circuit 140B.

FIG. 14C shows the output waveform at point C1 of the detection circuit 140B.

FIG. 14D shows the output waveform at point D1 of the detection circuit 140B.

Next, the ADC 147B1 outputs a predetermined AD value, for example, −0.3, corresponding to the signal of the integrator 146B1.

FIG. 14E shows the output waveform at point C2.

FIG. 14F shows the output waveform at point D2.

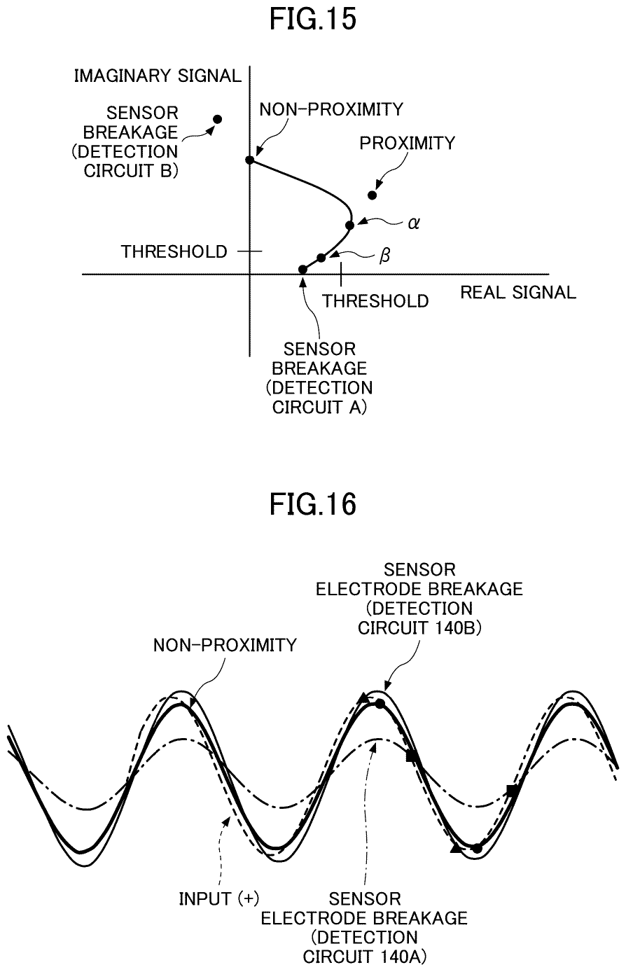

Next, the ADC 147B2 outputs a predetermined AD value, for example, 1.2, corresponding to the signal of the integrator 146B2. In other words, when the sensor electrode 110 is broken, the real and imaginary signals of the sensor circuit B are plotted at the positions shown in FIG. 15 below.

Next, as illustrated in FIG. 15, when a breakage occurs, the real part increases and the imaginary part decreases in the detection circuit 140A as compared with the non-proximity state, and conversely, the real part decreases and the imaginary part increases in the detection circuit 140B.

FIG. 16 illustrates the relationship between the waveforms of the aforementioned voltages that are input to the differential amplifiers of the detection circuit 140A and the detection circuit 140B, that is, the signals at point A, and is an exaggerated diagram showing the relationship between the waveforms of the voltages that are input to the non-inverting input (+) and the inverting input (−) when a hand is not in proximity (when the sensor electrode 110 is operating normally) and when a breakage has occurred, respectively, to the detection circuits 140A and 140B. As illustrated in the drawing, the amplitude of the detection circuit 140A whose capacitance value is less than ½ becomes smaller as compared with the non-proximity state, and the amplitude of the detection circuit 140B whose capacitance value exceeds ½ becomes larger as compared with the initial state. The phases of the signals of the detection circuits 140A and 140B when a hand is not in proximity and when a breakage has occurred and are the same, and the phases are delayed with respect to the input signal of the non-inverting input (+).

Hereinafter, the reasons why the amplitude of the detection circuit 140A whose capacitance value is less than ½ becomes smaller as compared with the non-proximity state, and the amplitude of the detection circuit 140B whose capacitance value exceeds ½ becomes larger as compared with the initial state will be roughly explained.

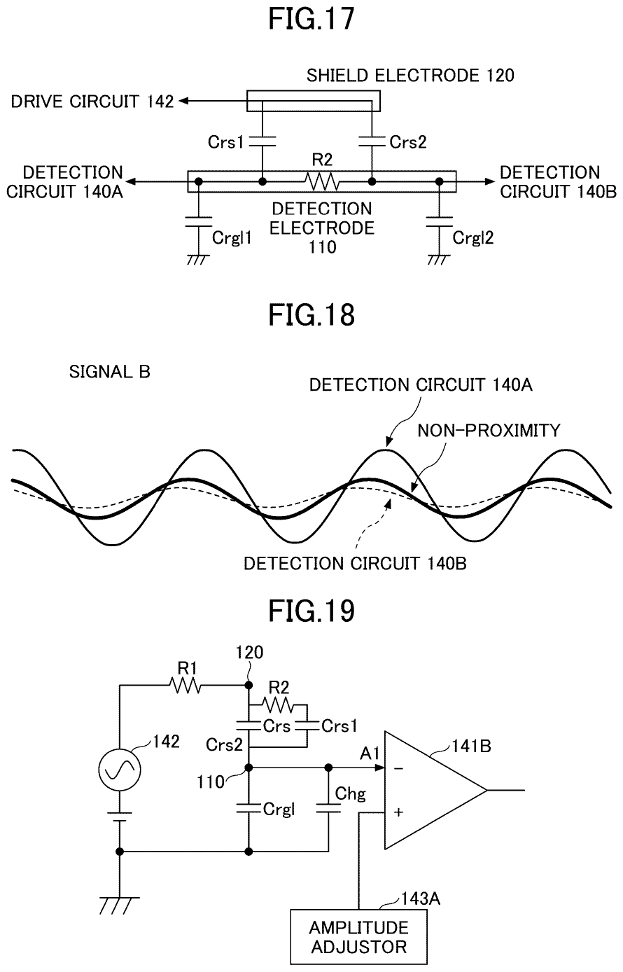

Focusing mainly on the sensor electrode 110 and the shield electrode 120, an equivalent circuit in a state where a crack has formed is illustrated in FIG. 17. Although the equivalent circuit is basically the same as that illustrated in FIG. 9, for convenience, the capacitance (stray capacitance) between the sensor electrode 110 and the ground 1 is divided into Crgl1 and Crgl2 corresponding to the crack in the sensor electrode 110. Since there is no difference in the result even if there is no resistor R1, the description will be omitted here.

First, in a state where no crack has formed in the sensor electrode 110, the resistor R2 is 0, and the capacitance of the shield electrode 120 and the sensor electrode 110 is Crs, which is the sum of Crs1 and Crs2. The capacitance (stray capacitance) between the sensor electrode 110 and the ground 1 is Crgl, which is the sum of Crgl1 and Crgl2. Therefore, the voltages measured by the detection circuit 140A and the detection circuit 140B can be roughly expressed by the following expression, wherein, V represents the voltage of the drive circuit 142:

V×(Crs1+Crs2)/(Crs1+Crs2+Crgl1+Crgl2) . . . Expression (1)

Next, when the sensor electrode 110 is in a broken state and R2 is very large, the voltage output to the detection circuit 140A can be expressed by the following expression:

V×(Crs1)/(Crs1+Crgl1) . . . Expression (2)

The voltage output to the detection circuit 140B when the sensor electrode 110 is in a broken state can be expressed by the following expression:

V×(Crs2)/(Crs2+Crgl2) . . . Expression (3)

Herein, it is assumed that Crs1=Crs2, that is, the area of the electrode broken from one end side of the sensor electrode 110 is the same as the area of the electrode broken from the other end side. In this state, Crgl1=Crgl2, and Expression (1)=Expression (2)=Expression (3). In other words, the voltages that are output to the detection circuit 140A and the detection circuit 140B do not change in the non-proximity state and the broken state.

However, if Crs1 is less than ½ of Crs, that is, if Crs2 is greater than ½ of Crs, the value of Expression (2) increases and the value of Expression (3) decreases as compared with the value of Expression (1). Therefore, in the detection circuit 140A whose capacitance value is less than ½, the amplitude decreases as compared with the non-proximity state, and in the detection circuit 140B whose capacitance value is greater than ½, the amplitude increases as compared with the initial state.

Specifically, for example, it is assumed that Crs is 5,000 pF, Crs1 is 1,000 pF, Crs2 is 4,000 pF, the stray capacitance of the sensor electrode 110 is 50 pF, and the stray capacitance of the wire or the like of the detection circuits 140A and 140B is 100 pF. For simplicity, the stray capacitance of the wire or the like is calculated by including itself in the stray capacitance of the sensor electrode 110, and if Crgl1 is (50×(1000/5000)+100) pF, namely 110 pF, and Crgl2 is (50×(4000/5000)+100) pF=140 pF, then Crgl is 250 pF.

Substituting this result into Expression (1) yields 0.952×V, substituting the result into Expression (2) yields 0.900×V, and substituting the result into Expression (3) yields 0.966×V. The voltage output to the detection circuit 140A decreases as compared with the non-proximity state, but the voltage output to the detection circuit B increases and shows the opposite behavior.

In this way, the amplitude of the signal at point A increases in the detection circuit 140A and decreases in the detection circuit 140B as compared with the non-proximity state.

Then, as shown in FIG. 16, when the non-proximity state is changed to the broken state, the intersection with the input (+) changes from the point indicated by the circle to the point indicated by the square in the detection circuit 140A and the phase is delayed as the voltage increases or decreases, and the phase is advanced from the point indicated by the circle to the point indicated by the triangle in the detection circuit 140B. In this way, the phase is delayed when the amplitude decreases, and the phase is advanced when the amplitude increases. Therefore, signal B has the waveform shown in FIG. 18, and the increasing relationship between the amplitude and the phase with respect to the non-proximity state is opposite in the detection circuits 140A and 140B.

Then, since the amplitude corresponds to the real signal and the phase corresponds to the imaginary signal, the real part increases and the imaginary part decreases in the detection circuit 140A when a breakage occurs, and conversely, the real part decreases and the imaginary part increases in the detection circuit 140B.

### When Crack Has Formed in Sensor Electrode 110

FIG. 19 is a diagram showing an equivalent circuit when a crack has formed in the sensor electrode 110. The difference from the detection circuit 140A illustrated in FIG. 9 is that the detection circuit 140B has a series circuit of Crs1 and R2 and a parallel connection of Crs2, while the detection circuit 140A has a series circuit of Crs2 and R2 and a parallel connection of Crs1 between the sensor electrode 110 and the shield electrode 120.

### When Crack Has Formed

In the following, a simulation is performed using the equivalent circuit illustrated in FIG. 19 with respect to a state where a crack has formed at a position illustrated in FIG. 8, and the results obtained in the same manner as above are shown. When a small crack α has occurred, the value of the ADC 147B1 is −0.45, and the value of the ADC 147B is 1.05. When a large crack β has occurred, the value of the ADC 147B1 is −0.4, and the value of the ADC 147B is 1.15.

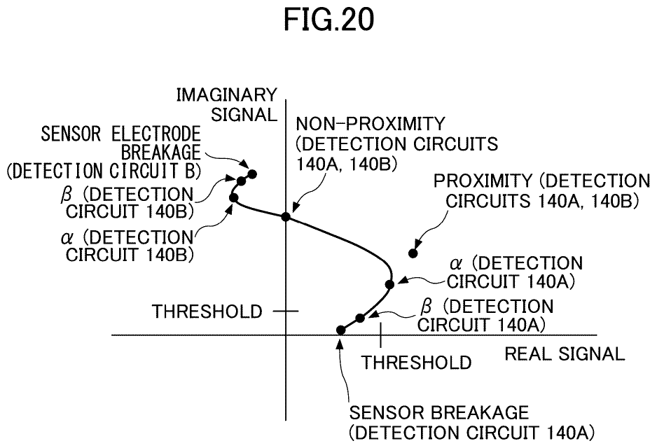

FIG. 20 shows the results obtained by setting the resistor R2 to a value of several points between 0 and infinity, obtaining the real part and the imaginary part by simulation, and connecting them.

As is clear from FIG. 20, the values of the real part and the imaginary part that are output to the detection circuits 140A and 140B when a crack has formed and when a breakage has occurred exhibit characteristics in which the positive side and the negative sign are reversed between when a crack has formed and when a breakage has occurred. Although they show a tendency toward point symmetry about the non-proximity state, they are not perfectly point-symmetric. Furthermore, when the hand H is in proximity, both the detection circuit 140A and the detection circuit 140B exhibit the same behavior, and therefore take the same real and imaginary values.

### Determination Processing of Determiner 151

The determiner 151 determines whether or not the hand H is in contact with the rim 11 by determining whether or not the signal values of the first real signal and the second real signal are equal to or higher than the contact determination threshold. However, as described above, when damage such as a crack, etc. has formed in the sensor electrode 110 and the impedance changes, it may not be possible to correctly determine whether or not the hand H is in contact with the rim 11.

Therefore, as one embodiment, the determiner 151 determines the value of the square root sum of the difference between the first real signal and the second real signal and the difference between the first imaginary signal and the second imaginary signal, determines whether or not the sensor electrode 110 is in an abnormal state based on whether or not the value is equal to or lower than the abnormality determination threshold, and reflects the determination result in the determination result of the contact determination.

### Determination Processing of Determiner 151

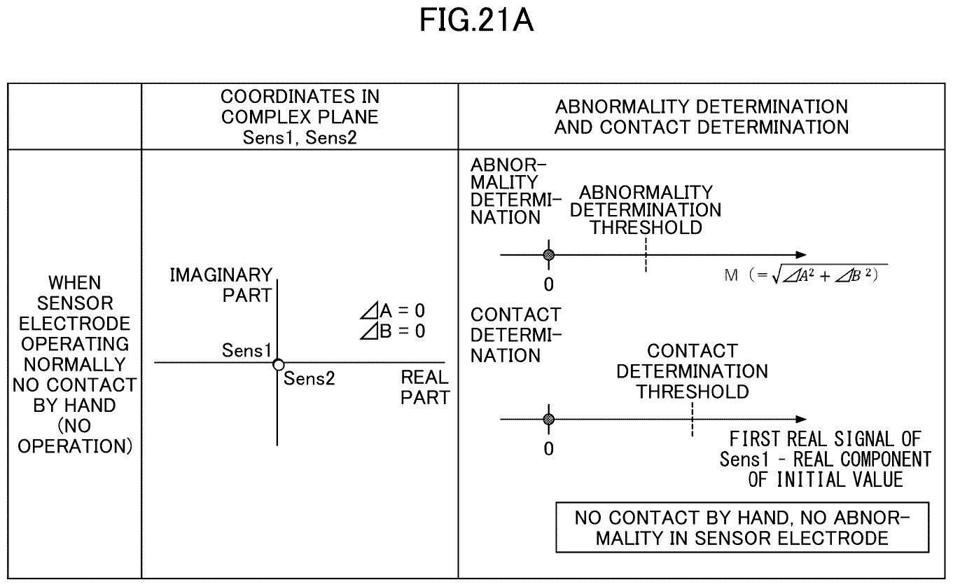

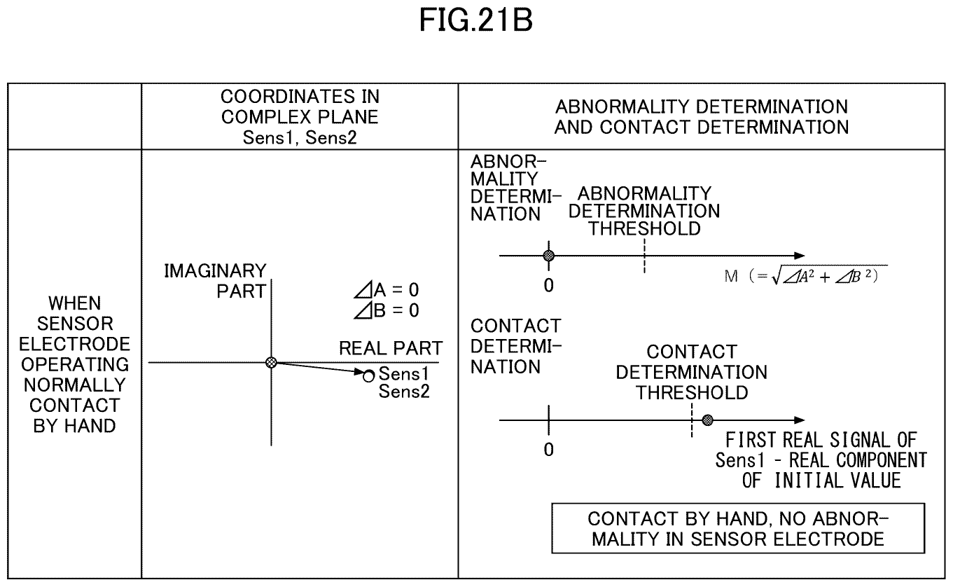

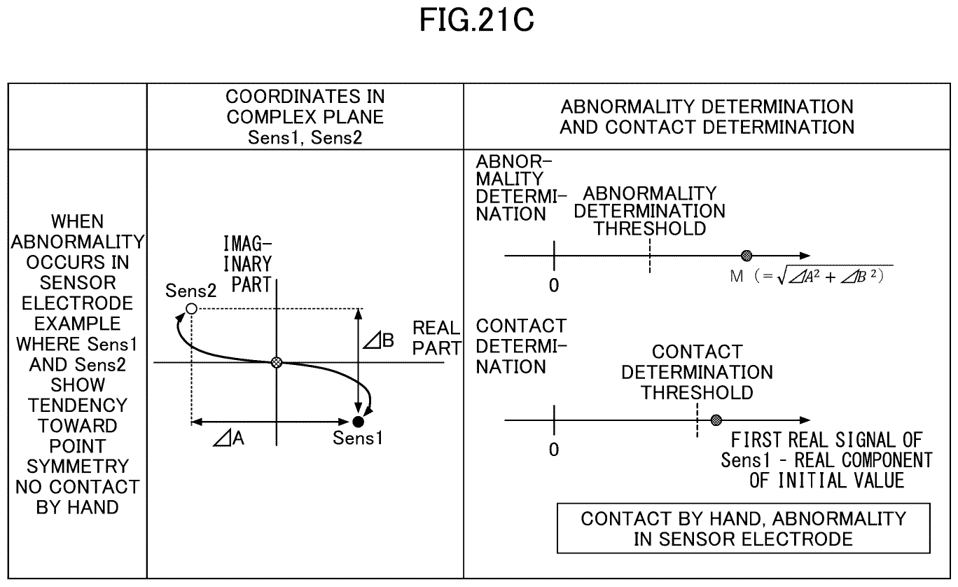

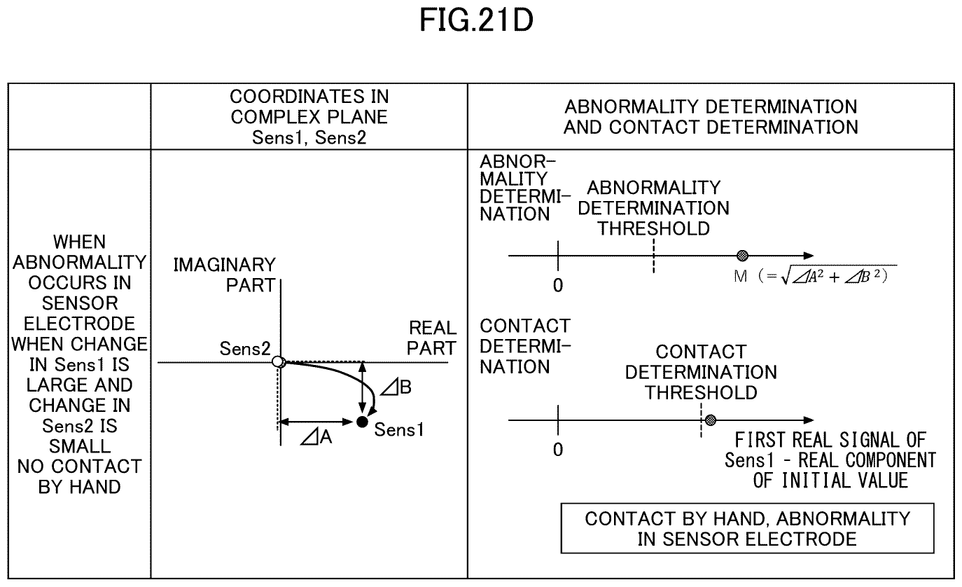

FIG. 21A is a diagram illustrating an example of the coordinates of the first detection signal Sens1 and the second detection signal Sens2 in the complex plane in a state where the sensor electrode 110 is operating normally, an abnormality, such as a crack, has not occurred, and the hand H is not in contact with the rim 11, and the results of the determination status of abnormality determination and contact determination. FIG. 21A corresponds to FIG. 20, but since FIG. 21A illustrates the difference between the real part and the imaginary part in the non-proximity state, FIG. 20 is redrawn with the real part and the imaginary part in the non-proximity state as the origin.

In a state where the sensor electrode 110 is operating normally and the hand H is not in contact with the rim 11, the coordinates of the first detection signal Sens1 and the second detection signal Sens2 in the complex plane on the real axis and the imaginary axis are the coordinates of the origin, as described above.

In the present example, in order to determine whether the sensor electrode 110 is broken or a crack larger than a predetermined size has formed, ΔA and ΔB are first determined. ΔA is an absolute value of a value obtained by subtracting the value A2 of the second real signal of the second detection signal Sens2 from the value A1 of the first real signal of the first detection signal Sens1. In other words, ΔA is expressed by the following Expression (4):
[Math. 1]

ΔB is the absolute value of the value obtained by subtracting the value B2 of the second imaginary signal of the second detection signal Sens2 from the value B1 of the first imaginary signal of the first detection signal Sens1. In other words, ΔB is expressed by the following Expression (5):
[Math. 2]

From Expressions (4) and (5), the root sum square M of the difference ΔA between the first real signal and the second real signal and the difference ΔB between the first imaginary signal and the second imaginary signal can be obtained by the following Expression (6):
[Math. 3]

The determiner 151 determines the root sum square M of the difference ΔA between the first real signal and the second real signal and the difference ΔB between the first imaginary signal and the second imaginary signal by Expression (6), and determines the presence or absence of an abnormality, such as a crack, in the sensor electrode 110 based on the value of the root sum square M.

The root sum square M is used to determine the presence or absence of an abnormality, such as a crack, in the sensor electrode 110 by observing the difference between the output (first output signal) of the first end portion 111 and the output (second output signal) of the second end portion 112 of the sensor electrode 110. Specifically, an alternating current signal input from the alternating current signal source 142A to the sensor electrode 110 via the shield electrode 120 returns to the electrostatic MCU 150 through both the first and second end portions, and the resulting signals are analyzed. When a crack forms such that the electrode area at the first end portion differs from that at the second end portion, and the non-proximity state is used as a reference, the real and imaginary parts of the signals from detection circuits 140A and 140B exhibit changes of opposite polarity. The presence or absence of an abnormality, such as a crack, is then determined by calculating the root sum square M.

In the present embodiment, the presence of a breakage as an abnormality is also determined by the root sum square M at the same time as when whether or not a crack has formed is determined, but it may be determined by the value of the imaginary part as in the comparative example.

When an abnormality, such as a crack, has not occurred in the sensor electrode 110, the output of the first end portion 111 (the first output signal) and the output of the second end portion 112 (the second output signal) are substantially equal, so that both ΔA and ΔB become substantially zero.

On the other hand, when an abnormality, such as a crack, occurs in the sensor electrode 110, ΔA and ΔB change, and the presence or absence of an abnormality in the sensor electrode 110 is determined by calculating the root sum square M of the difference ΔA between the first real signal and the second real signal and the difference ΔB between the first imaginary signal and the second imaginary signal using Expression (6), and comparing the root sum square M with an abnormality determination threshold.

Herein, as an example, the presence or absence of an abnormality in the sensor electrode 110 is determined by using the root sum square M of the difference ΔA between the first real signal and the second real signal and the difference ΔB between the first imaginary signal and the second imaginary signal. However, the determination processing of the presence or absence of an abnormality in the sensor electrode 110 is not limited to the determination processing using the root sum square M, and only the difference ΔA between the first real signal and the second real signal or the difference ΔB between the first imaginary signal and the second imaginary signal may be used. Alternatively, a difference between the difference ΔA between the first real signal and the second real signal and the difference ΔB between the first imaginary signal and the second imaginary signal or a ratio between the difference ΔA between the first real signal and the second real signal and the difference ΔB between the first imaginary signal and the second imaginary signal may be used.

Furthermore, the presence or absence of an abnormality in the sensor electrode 110 may be determined based on whether or not the absolute value of the first real signal and the second real signal meets or exceeds a predetermined value and their signs are opposite.

FIG. 21A shows a state in which the sensor electrode 110 is operating normally and the hand H is not in contact with the rim 11. Since the sensor electrode 110 is operating normally, the value does not change from the non-proximity state, and both ΔA and ΔB are zero.

As described above, since the origin is a state in which the hand H is not in contact with the rim 11, the coordinates of the first detection signal Sens1 and the second detection signal Sens2 are equal to the coordinates of the origin of the complex plane.

In the abnormality determination, since the root sum square M is zero and does not exceed than the abnormality determination threshold, the determiner 151 determines that the sensor electrode 110 is operating normally, that is, there is no crack or breakage larger than a predetermined size in the sensor electrode 110. In the contact determination, since the value obtained by subtracting the real component of the initial value from the first real signal of the first detection signal Sens1 is zero and is less than the contact determination threshold, the determiner 151 determines that the hand H is not in contact with the rim 11. The abnormality determination threshold is smaller than the contact determination threshold.

When an abnormality occurs at the intermediate position of the sensor electrode 110, the characteristics are similar to those shown in FIG. 21A; however, as described later, abnormalities are less likely to occur at this intermediate position

FIG. 21B is a diagram illustrating an example of the coordinates of the first detection signal Sens1 and the second detection signal Sens2 in the complex plane and the result of the determination status of the abnormality determination and the contact determination in the state where the sensor electrode 110 is operating normally and an abnormality, such as a crack or a breakage, has not occurred and the hand H is in contact with the rim 11.

Since the sensor electrode 110 is operating normally, the coordinates of the first detection signal Sens1 and the second detection signal Sens2 in the complex plane are equal to each other and are located in the fourth quadrant as an example. Therefore, both ΔA and ΔB are zero.

Since the hand H is in contact with the rim 11, the coordinates of the first detection signal Sens1 and the second detection signal Sens2 are shifted from the origin and are located in the fourth quadrant as an example. Since the hand H is in contact with the rim 11, the impedance of the sensor electrode 110 is changed, and the shift from the origin (initial value) occurs.

In the abnormality determination, since the root sum square M is zero and therefore does not exceed the abnormality determination threshold, the determiner 151 determines that the sensor electrode 110 is operating normally. In the contact determination, since the value obtained by subtracting the real component of the initial value from the first real signal of the first detection signal Sens1 is equal to or greater than the contact determination threshold, the determiner 151 determines that the hand H is in contact with the rim 11.

FIG. 21C is a diagram showing an example of the coordinates of the first detection signal Sens1 and the second detection signal Sens2 on the complex plane and the result of the determination status of abnormality determination and contact determination in an abnormal state in which a crack has formed in the sensor electrode 110 at a non-neutral position as shown in FIG. 8 and the hand H is not in contact with the rim 11.

Since the sensor electrode 110 is in an abnormal state, the coordinates of the first detection signal Sens1 and the second detection signal Sens2 on the complex plane are different, and as an example, the first detection signal Sens1 is located in the fourth quadrant and the second detection signal Sens2 is located in the second quadrant. Therefore, both ΔA and ΔB are not zero.

Although the hand H is not in contact with the rim 11, since the impedance of the sensor electrode 110 is deviated from the initial value due to an abnormality in the sensor electrode 110, the root sum square M meets or exceeds the abnormality determination threshold in the abnormality determination, and the determiner 151 determines that the sensor electrode 110 is in an abnormal state. Since the contact determination is performed using the same threshold value by the same method as in the comparative example, the value obtained by subtracting the real component of the initial value from the first real signal of the first detection signal Sens1 is equal to or greater than the contact determination threshold in the contact determination, and the determiner 151 erroneously determines that the hand H is in contact with the rim 11. However, when the abnormality determination is performed, an erroneous determination can be prevented by not considering the contact even if it is determined that the hand H is in contact with the rim 11.

Since the abnormality determination threshold is smaller than the contact determination threshold, the root sum square M always exceeds the abnormality determination value before the value of the first real signal of the first detection signal Sens1 exceeds the contact determination threshold. Therefore, when the sensor electrode 110 is in an abnormal state in which a crack or the like has occurred, it is possible to prevent the determiner 151 from erroneously determining that the sensor electrode 110 is operating normally in the abnormality determination and that the hand H is in contact with the rim 11 in the contact determination.

FIG. 21D is a diagram showing an example of the coordinates of the first detection signal Sens1 and the second detection signal Sens2 in the complex plane in a state in which a crack or the like has occurred in the vicinity of the first end portion 111 of the sensor electrode 110 and the hand H is not in contact with the rim 11, and the results of the determination situations of the abnormality determination and the contact determination.

When the sensor electrode 110 is in an abnormal state and a crack or the like has occurred in the vicinity of the first end portion 111 of the sensor electrode 110, the impedance of the sensor electrode 110 connected to the first end portion 111 greatly changes from the initial value in which there is no crack, and the impedance of the sensor electrode 110 connected to the second end portion 112 hardly changes from the initial value in which there is no crack. Therefore, the coordinates of the first detection signal Sens1 and the second detection signal Sens2 in the complex plane are different, and as an example, the first detection signal Sens1 is located in the fourth quadrant, and the second detection signal Sens2 is located near the origin. Therefore, both ΔA and ΔB are not zero.

When the sensor electrode 110 is in an abnormal state, the impedance of the sensor electrode 110 deviates from the initial value, and the root sum square M exceeds the abnormality determination threshold, and therefore, in the abnormality determination, the determiner 151 determines that the sensor electrode 110 is in an abnormal state. When the hand H is in contact with the rim 11, the value obtained by subtracting the real component of the initial value from the first real signal of the first detection signal Sens1 is equal to or greater than the contact determination threshold, and therefore, it is erroneously determined that the hand H is in contact, but the determiner 151 does not perform the contact determination because the sensor electrode 110 is in an abnormal state. In other words, the determiner 151 determines that the sensor electrode 110 is in an abnormal state and notifies the ECU or the like of the vehicle connected to the electrostatic MCU 150 of the determination result.

### Flowchart

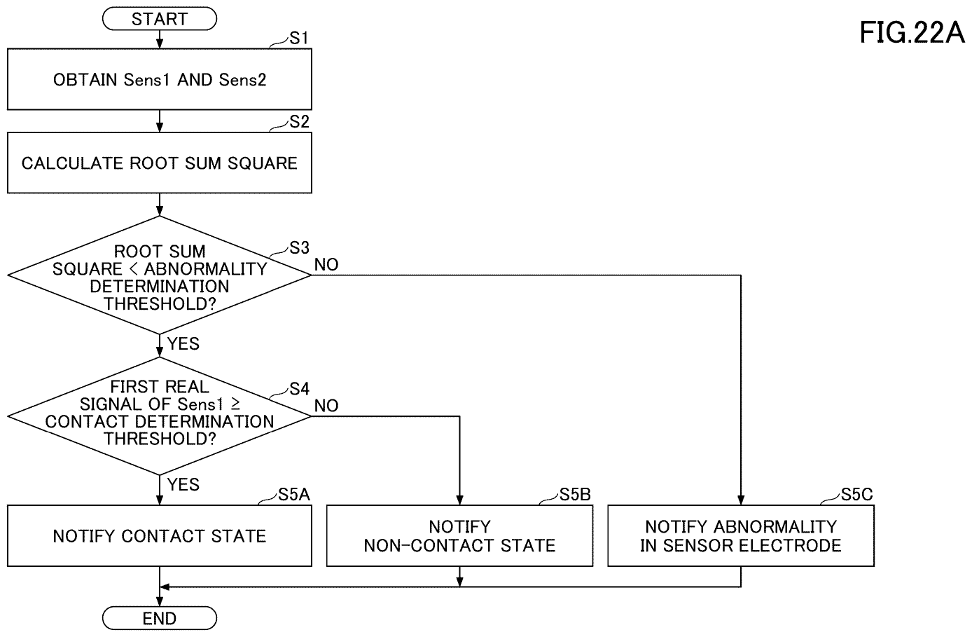

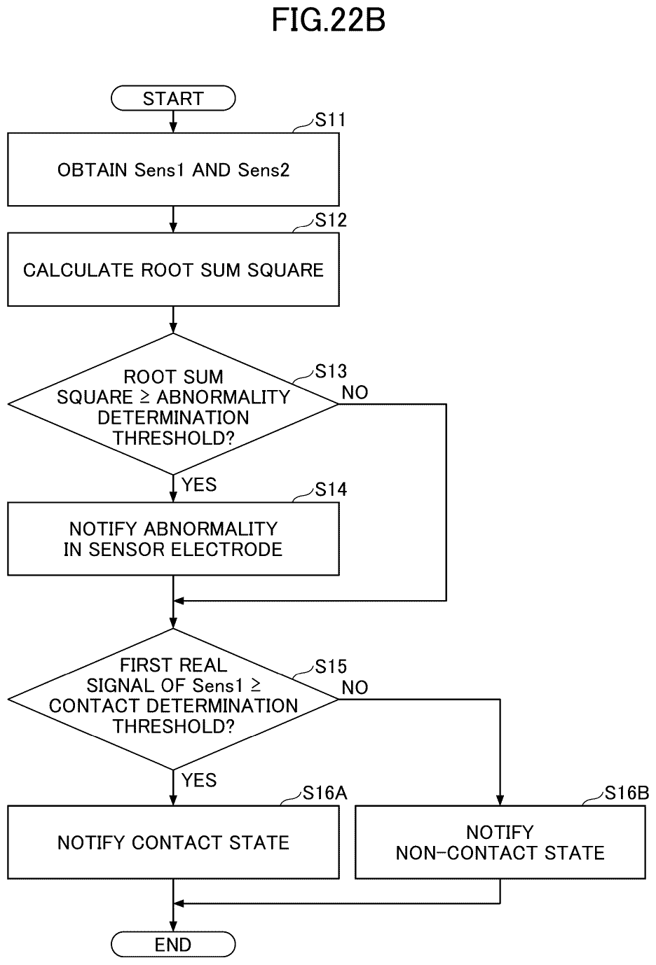

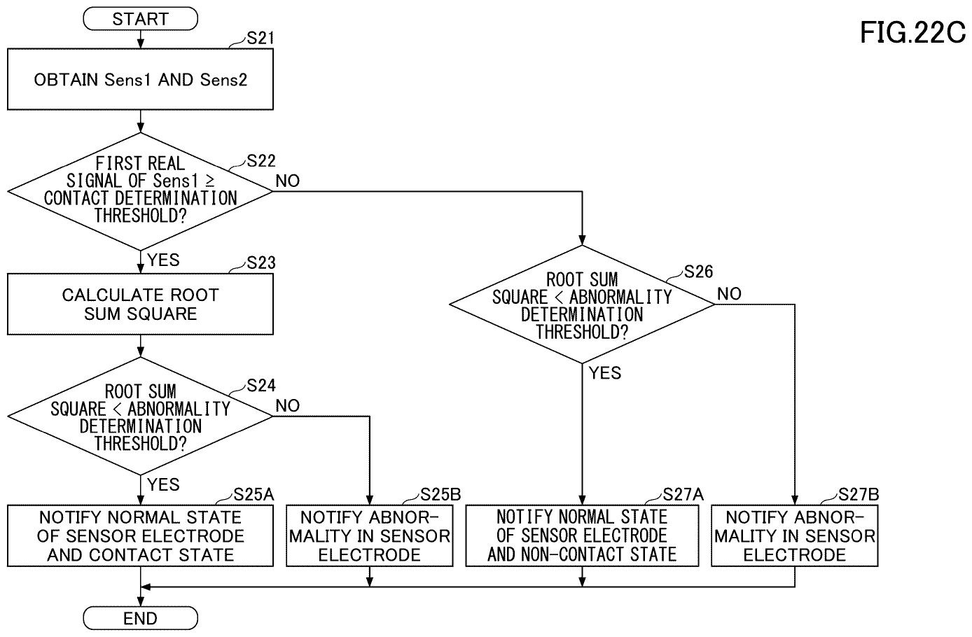

FIGS. 22A through 22C are flowcharts showing examples of the processing performed by the determiner 151 of the contact determination apparatus 100. Here, three types of the determination processing will be described with reference to FIGS. 22A through 22C. Herein, as an example, the processing in which the determiner 151 notifies the ECU of the vehicle of the determination result will be described.

### Determination Processing of FIG. 22A

When the processing is started, the determiner 151 acquires the first detection signal Sens1 and the second detection signal Sens2 (step S1).

The determiner 151 calculates the root sum square M based on Expression (6) (step S2).

The determiner 151 determines whether the root sum square M does not exceed the abnormality determination threshold (step S3).

When the determiner 151 determines that the root sum square M does not exceed the abnormality determination threshold (Yes in step S3), the determiner 151 determines whether the value of the first real signal of the first detection signal Sens1 is equal to or greater than the contact determination threshold (step S4).

When the determiner 151 determines that the value of the first real signal of the first detection signal Sens1 is equal to or greater than the contact determination threshold (Yes in step S4), the determiner 151 determines that the vehicle is in a contact state and notifies the ECU of the vehicle of the contact state (step S5A). When the determiner 151 finishes the processing of step S5A, the determiner 15 ends the processing for a single control cycle.

When the determiner 151 determines in step S3 that the root sum square M meets or exceeds the abnormality determination threshold (No in step S3), the determiner 151 determines that the sensor electrode 110 is in an abnormal state and notifies the ECU of the vehicle of an abnormality in the sensor electrode 110 (step S5C). This is because the root sum square M is equal to or greater than the abnormality determination threshold, and the impedance changes due to a crack or the like in sensor electrode 110, resulting in an abnormal state. Upon completion of step S5C, the determiner 151 ends the processing for a single control cycle.

If the determiner 151 determines in step S4 that the value of the first real signal of the first detection signal Sens1 is not greater than the contact determination threshold (No in step S4), the determiner 151 determines that the vehicle is in a non-contact state and notifies the ECU of the vehicle of the non-contact state (step S5B). In the non-contact state, the hand H is not touching the rim 11 of the steering wheel 10, in other words, the hand H of the vehicle driver is not in contact with the steering wheel 10. Upon completion of step S5B, the determiner 151 ends the processing for a single control cycle.

As described above, in the determination processing illustrated in FIG. 22A, the determiner 151 can determine the contact state in which the hand H of the vehicle driver is in contact with the rim 11 of the steering wheel 10 (step S5A), the non-contact state in which the hand H of the vehicle driver is not in contact with the rim 11 of the steering wheel 10 (step S5B), and the abnormal state of the sensor electrode 110 (step S5C). The determiner 151 can notify the ECU of the vehicle of the determination result.

In the determination processing illustrated in FIG. 22A, the determiner 151 does not determine whether the hand H is in contact with the rim 11 or not if there is an abnormality in the sensor electrode 110, and determines whether the hand H is in contact with the rim 11 or not if there is no abnormality.

### Determination Processing of FIG. 22B

When the processing is started, the determiner 151 acquires the first detection signal Sens1 and the second detection signal Sens2 (step S11).

The determiner 151 calculates the root sum square M based on Expression (6) (step S12).

The determiner 151 determines whether the root sum square M meets or exceeds the abnormality determination threshold (step S13).

When the determiner 151 determines that the root sum square M meets or exceeds the abnormality determination threshold (Yes in step S13), the determiner 151 determines that the sensor electrode 110 is in an abnormal state, and notifies the vehicle ECU of an abnormality in the sensor electrode 110 (step S14). This is because the root sum square M is equal to or greater than the abnormality determination threshold, and the impedance changes due to a crack or the like in sensor electrode 110, resulting in an abnormal state.

Upon completion of step S14, the determiner 151 proceeds to step S15. If the determiner 151 determines in step S13 that the root sum square M does not exceed the abnormality determination threshold (No in step S13), the flow proceeds to step S15.

The determiner 151 determines whether the value of the first real signal of the first detection signal Sens1 is equal to or greater than the contact determination threshold (step S15).

Upon determination that the value of the first real signal of the first detection signal Sens1 is equal to or greater than the contact determination threshold (Yes in step S15), the determiner 151 determines that the hand H is in contact with the rim 11, and notifies the ECU of the vehicle of the contact state (step S16A). Upon completion of step S16A, the determiner 151 ends the processing for a single control cycle.

If the determiner 151 determines in step S15 that the value of the first real signal of the first detection signal Sens1 is not equal to or greater than the contact determination threshold (No in step S15), the determiner 151 determines that the hand H is not in contact with the rim 11 and notifies the ECU of the vehicle of the non-contact state (step S16B). Upon completion of step S15B, the determiner 151 ends the processing for a single control cycle.

As described above, in the determination processing illustrated in FIG. 22B, in the case where an abnormality has occurred in the sensor electrode 110, the determiner 151 determines an abnormal state of the sensor electrode 110 (step S14), and can determine a contact state in which the hand H of the vehicle driver is in contact with the rim 11 of the steering wheel 10 (step S16A), or a non-contact state in which the hand H of the vehicle driver is not in contact with the rim 11 of the steering wheel 10 (step S16B). The determiner 151 can notify the ECU of the vehicle of the determination result.

In the determination processing illustrated in FIG. 22B, the determiner 151 determines whether the hand H is in contact with the rim 11 or not regardless of the result of the abnormality determination in the sensor electrode 110, but when an abnormality occurs in the sensor electrode 110, the ECU of the vehicle ignores the determination of whether the hand H is in contact with the rim 11 or not.

### Determination Processing of FIG. 22C

When the processing is started, the determiner 151 acquires the first detection signal Sens1 and the second detection signal Sens2 (step S21).

The determiner 151 determines whether the value of the first real signal of the first detection signal Sens1 is equal to or greater than the contact determination threshold (step S22).

If the determiner 151 determines that the value of the first real signal of the first detection signal Sens1 is equal to or greater than the contact determination threshold (Yes in step S22), the determiner 151 calculates the root sum square M based on Expression (6) (step S23).

The determiner 151 determines whether the root sum square M does not exceed the abnormality determination threshold (step S24).

If the determiner 151 determines that the root sum square M does not exceed the abnormality determination threshold (Yes in step S24), the determiner 151 determines that the hand H is in contact with the rim 11 of the steering wheel 10, and notifies the ECU of the vehicle that the sensor electrode 110 is operating normally and in the contact state (step S25A). Upon completion of step S25A, the determiner 151 ends the processing for a single control cycle.

If the determiner 151 determines that the root sum square M meets or exceeds the abnormality determination threshold (No in step S24) in step S24, the determiner 151 determines that the sensor electrode 110 is in an abnormal state and notifies the vehicle ECU of an abnormality in the sensor electrode 110 (step S25B). This is because the root sum square M is equal to or greater than the abnormality determination threshold, and the impedance changes due to a crack or the like in the sensor electrode 110, resulting in an abnormal state. Since the sensor electrode 110 is in an abnormal state, the ECU of the vehicle is notified that the sensor electrode 110 is in an abnormal state without notifying the contact state. Upon completion of step S25B, the determiner 151 ends the processing for a single control cycle.

If the determiner 151 determines in step S22 that the value of the first real signal of the first detection signal Sens1 is not equal to or greater than the contact determination threshold (No in step S22), the determiner 151 determines whether the root sum square M does not exceed the abnormality determination threshold (step S26).

If the determiner 151 determines that the root sum square M does not exceed the abnormality determination threshold (Yes in S26), the determiner 151 determines that the sensor electrode 110 is operated normally and the hand H is in contact with the rim 11 of the steering wheel 10, and notifies the ECU of the vehicle (step S27A). Upon completion of step S27A, the determiner 151 ends the processing for a single control cycle.

If the determiner 151 determines that the root sum square M meets or exceeds the abnormality determination threshold (No in step S26) in step S26, the determiner 151 determines that the sensor electrode 110 is in an abnormal state and notifies the vehicle ECU of an abnormality in the sensor electrode 110 (step S27B). This is because the root sum square M is equal to or greater than the abnormality determination threshold, and the impedance changes due to a crack or the like in sensor electrode 110, resulting in an abnormal state. Since the sensor electrode 110 is in an abnormal state, the ECU of the vehicle is notified that the sensor electrode 110 is in an abnormal state without notifying the non-contact state. Upon completion of step S27B, the determiner 151 ends the processing for a single control cycle.

In this embodiment, the contact detection is determined only by determining whether the real number portion is equal to or greater than a predetermined value, but the determination may be made by specifying a range of both the real number portion and the imaginary number portion, such as an absolute value of the imaginary number being equal to or less than a predetermined value.

In addition, in the present embodiment, the proximity detection and the determination of a breakage and a crack in the sensor electrode are described, and a detailed description of the short circuit between the sensor electrode 110 and the shield electrode and the open circuit of the shield electrode are omitted because they are different from the main object of the present invention, but these can be detected by setting an appropriate threshold value.

### How to Mount Sensor Electrode 110 on Rim 11

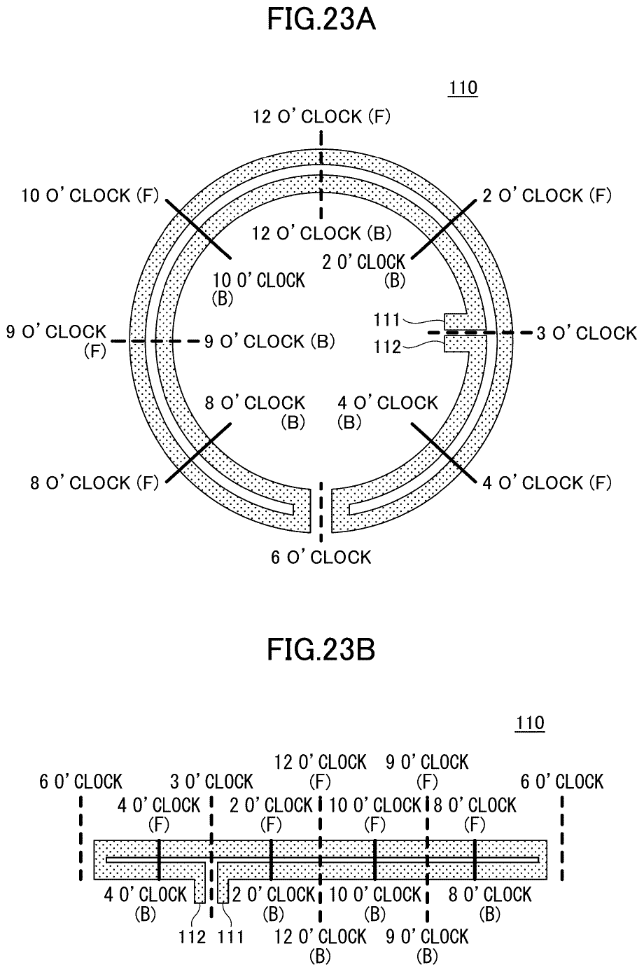

FIGS. 23A and 23B are diagrams for explaining an example of how the sensor electrode 110 is mounted on the rim 11. FIG. 23A illustrates the shape of the sensor electrode 110 mounted on the rim 11 (see FIG. 1). FIG. 23A illustrates the circumferential position of the rim 11, as viewed from the driver side of the steering wheel 10, is indicated from the 12 o'clock (0 o'clock) position to the 10 o'clock position on a clock face. FIG. 23A illustrates only the 2 o'clock, 3 o'clock, 4 o'clock, 6 o'clock, 8 o'clock, 9 o'clock, 10 o'clock, and 12 o'clock positions. FIG. 23B illustrates the shape of the sensor electrode 110 before the sensor electrode 110 is mounted on the steering wheel 10, and the circumferential position when the sensor electrode 110 is mounted on the steering wheel 10.

Although the shield electrode 120 provided on the surface of the resin film as described above is mounted on the rim 11 in a state overlapped with the sensor electrode 110 provided on the surface of the resin film, the resin film and the shield electrode 120 will be omitted in the following description.

As an example, the sensor electrode 110 is mounted on the rim 11 while the sensor electrode 110 is bent along the shape of the rim 11, the first end portion 111 and the second end portion 112 are arranged at the 3 o'clock position, and the front surface of the rim 11 (the front side in the vehicle) and the rear surface of the rim 11 (on the rear side of the vehicle and on the driver's side) are separated. In FIGS. 23A and 23B, at each of the 2, 4, 8, 9, 10, and 12 o'clock positions of the rim 11, the front surface of the rim 11 is denoted by a subscript of “(F)”, and the rear surface of the rim 11 is denoted by a subscript of “(B)”.

The sensor electrode 110 is mounted on the rim 11 from the first end portion 111 at the 3 o'clock position, through the rear surface of the rim 11, through the 2 o'clock position (B), the 12 o'clock position (B), the 10 o'clock position (B), the 9 o'clock position (B), the 8 o'clock position (B), folded back from the rear surface to the front surface at the 6 o'clock position, through the 8 o'clock position (F), the 9 o'clock position (F), the 10 o'clock position (F), the 12 o'clock position (F), the 2 o'clock position (F), the 3 o'clock position (F), the 4 o'clock position (F), folded back from the front surface to the rear surface at the 6 o'clock position, through the 4 o'clock position (B), to the second end portion 112 at the 3 o'clock position.

As described above, the section of the sensor electrode 110 in which the front side of the rim 11 is covered is an example of a first section, and the section the rear side of the rim 11 is covered is an example of a second section. The portion where the sensor electrode 110 is folded back between the front surface and the rear surface of the rim 11 is an example of a folded-back portion. The sensor electrode 110 is not limited to the configuration in which the sensor electrode is separately mounted on the front surface of the rim 11 and the rear surface of the rim 11 as described above, but may be separately mounted on the outer peripheral surface of the rim 11 and the inner peripheral surface of the rim 11, for example. In either case, since the sensor electrodes are disposed on any of the front, rear, inner peripheral, and outer peripheral surfaces of the rim 11, it is possible to reliably detect contact by the hand H with the steering wheel 10 from any direction.

The sensor electrode 110 is fixed to the rim 11 by a plurality of fixing portions in the longitudinal direction of the sensor electrode 110 between the first end portion 111 at the 3 o'clock position and the second end portion 112 at the 3 o'clock position with respect to the rim 11.

By mounting the sensor electrode 110 on the rim 11 in this manner, it is possible to detect whether or not the hand H is in contact with the steering wheel 10 in the entire 360-degree circumferential direction of the rim 11 (from the 12 o'clock position to the 12 o'clock position).

If one of the spokes 13 is present at the 3 o'clock position, it may not be possible to mount the sensor electrode 110 so as to be continuous in the circumferential direction of the rim 11 across the spoke 13. In such a case, by arranging the first end portion 111 and the second end portion 112 so as to sandwich the spoke 13 in the circumferential direction of the rim 11, as illustrated in FIG. 23A, without crossing over the spoke 13 in the circumferential direction of the rim 11, the sensor electrode 110 can be reliably mounted on the rim 11.

Depending on the shape of the steering wheel 10, for example, due to the presence of the spoke 13 at the 6 o'clock position, it may not be possible to mount the sensor electrode 110 so as to be continuous in the circumferential direction of the rim 11 across the spoke 13 located at the 6 o'clock position. In such a case, for example, as illustrated in FIG. 23A, the sensor electrode 110 can be reliably mounted on the rim 11 by providing the sensor electrode 110 with the folded-back portion at the 6 o'clock position.

The position at which a first impedance as viewed from the first end portion 111 of the sensor electrode 110 is equal to a second impedance as viewed from the second end portion 112 of the sensor electrode 110 is configured to be different from a plurality of positions at which the plurality of fixing portions are provided. The fixing portion is, for example, a portion where the sensor electrode 110 (see FIG. 2A) is fixed to the rim 11 by an adhesive or the like.

Since the sensor electrode 110 is fixed to the rim 11 at the fixing portions, the stress applied to the sensor electrode 110 during the operation of the steering wheel 10 by the driver is larger than that in the section of the sensor electrode 110 not fixed by the fixing portions, such that cracks or the like would be more likely to occur in the section of the sensor electrode 110 fixed by the fixing portions.

For this reason, the position at which the first impedance seen from the first end portion 111 of the sensor electrode 110 is equal to the second impedance seen from the second end portion 112 of the sensor electrode 110 is configured to be different from the positions of a plurality of fixing portions, so that even if the impedance changes due to a crack or the like at one of the fixing portions of the sensor electrode 110, an abnormality in the sensor electrode 110 can be reliably detected.

In order to realize the relationship between the first impedance and the second impedance as described above, the capacitance of the sensor electrode 110 between the first end portion 111 and the position located at a first distance is configured to differ from the capacitance of the sensor electrode 110 between the second end portion 112 and the position located at the first distance. Herein, the position located at the first distance corresponds to a fixing portion of the sensor electrode 110 in the present embodiment, but may correspond to a portion where a crack is likely to form in the sensor electrode 110 for another reason, that is, a portion where a crack is likely to form more easily than in other electrode portions.

In the present embodiment, the sensor electrode 110 is fixed to the rim 11 at four locations at the 2, 10, 8, and 4 o'clock positions. Therefore, for example, when an abnormality, such as a crack, occurs at one of these four fixing portions, the capacitance between the first end portion 111 and the fixing portion where the crack occurs located at the first distance differs from the capacitance between the second end portion 112 of the sensor electrode 110 and the fixing portion where the crack occurs located at the first distance. Therefore, even when a crack has formed in the sensor electrode 110 at the plurality of fixing portions, an abnormality in the sensor electrode 110 can be detected.

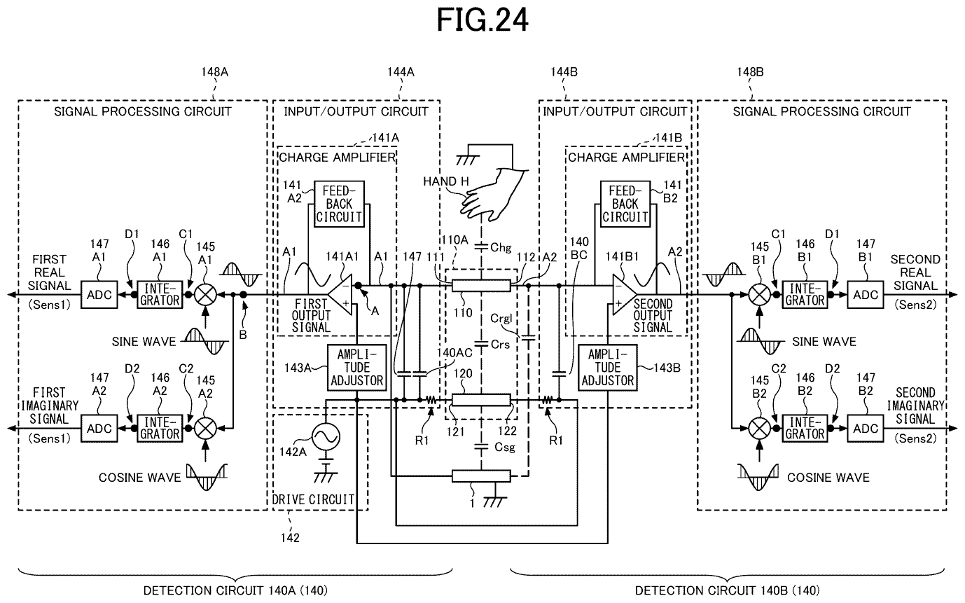

Furthermore, as illustrated in FIG. 24, in order to realize a configuration in which the capacitance between the first end portion 111 of the sensor electrode 110 and the position located at the first distance differs from the capacitance between the second end portion 112 of the sensor electrode 110 and the position located at the first distance, a configuration further including a capacitor 147 provided in series between the first end portion 111 of the sensor electrode 110 and the output potential point of the drive circuit 142 may be adopted. More specifically, the capacitor 147 is inserted in series between the first end portion 111 of the sensor electrode 110 and the output terminal of the alternating current signal source 142A. The capacitor 147 may also be provided between the second end portion 112 of the sensor electrode 110 and the reference potential point.

In this case, even when cracks occur at a plurality of positions such as at the 2 o'clock position and the 4 o'clock position, for example, a configuration in which the capacitance between the first end portion 111 of the sensor electrode 110 and the position at the 2 o'clock position (B) differs from the capacitance between the second end portion 112 of the sensor electrode 110 and the position at the 4 o'clock position (B) can be realized.

### How to Mount Sensor Electrode 110 on Rim 11

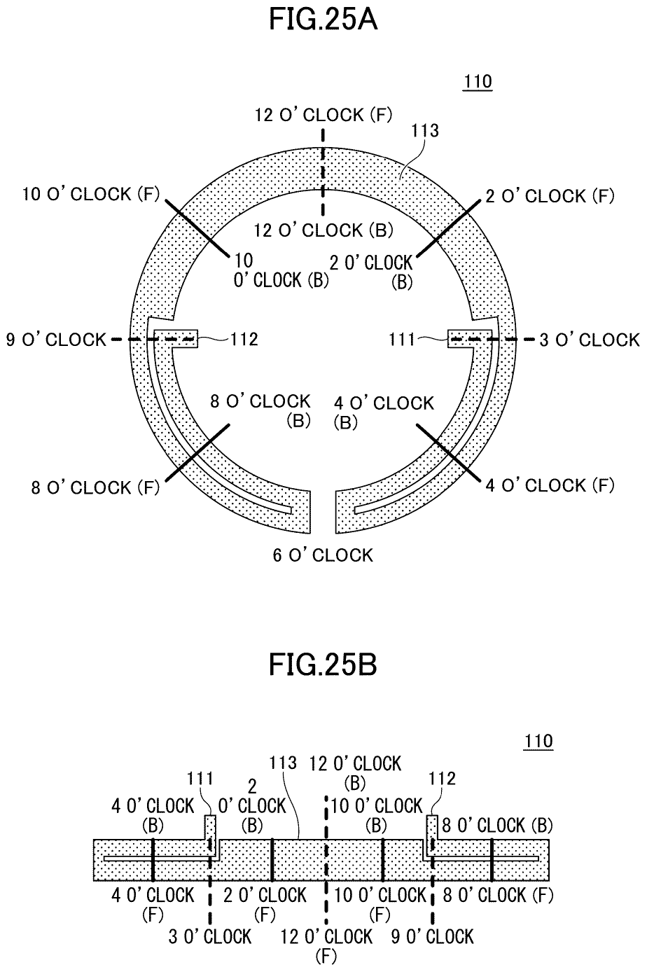

FIGS. 25A and 25B are diagrams for explaining a modified example of mounting the sensor electrode 110 on the rim 11, wherein FIG. 25A illustrates a state in which the sensor electrode is mounted on the rim 11, and FIG. 25B illustrates a state before mounting the sensor electrode on the rim 11. Herein, differences from the sensor electrode 110 illustrated in FIGS. 23A and 23B will be described. In FIGS. 25A and 25B, the rim 11 is omitted.

By way of example, the sensor electrode 110 is mounted on the rim 11 by placing the first end portion 111 at the 3 o'clock position, placing the second end portion 112 at the 9 o'clock position, and separating the front surface of the rim 11 (the front side in the vehicle) and the rear surface of the rim 11 (on the rear side of the vehicle and on the driver's side.).

The sensor electrode 110 is mounted on the rim 11 so as to pass from the first end portion 111 at the 3 o'clock position through the rear surface of the rim 11, pass through 4 o'clock position (B), be folded back from the rear surface to the front surface at the 6 o'clock position, and pass through the 4 o'clock position (F), the 3 o'clock position, the 2 o'clock position (F, B), the 12 o'clock position (F, B), the 10 o'clock position (F, B), the 9 o'clock position, the 8 o'clock position (F), be folded back from the front surface to the rear surface at the 6 o'clock position, pass through the 8 o'clock position (B), and reach the second end portion 112 at the 9 o'clock position.

Since the section from the 3 o'clock position to the 12 o'clock (0 o'clock) position to the 9 o'clock position is mounted on both the front and rear sides, the sections for the 2 o'clock position, the 12 o'clock position, and the 10 o'clock position are described as the 2 o'clock position (F, B), the 12 o'clock position (F, B), and the 10 o'clock position (F, B). A wide section 113, which spans from the 3 o'clock to the 12 o'clock (0 o'clock) position to the 9 o'clock position and is mounted on both the front and rear sides, is wider than the section mounted only on the front or rear sides.

By mounting the sensor electrode 110 on the rim 11 in this manner, it is possible to detect whether or not the hand (H) is in contact with the rim 11 in the entire 360 degree area of the rim 11.

By having the wide section 113, the sensor electrode 110 can be easily mounted on the rim 11.

### Advantageous Effects

The contact determination apparatus 100 includes the sensor electrode 110 having the first end portion 111 and the second end portion 112 positioned at both ends and provided along the surface layer11A;

the shield electrode 120 provided facing the sensor electrode 110 and capacitively coupled to the sensor electrode 110; the alternating current signal source 142A configured to output an alternating current signal to the sensor electrode 110 or the shield electrode 120; the first wire connected to the first end portion 111 of the sensor electrode 111; the second wire connected to the second end portion 112 of the sensor electrode 110; and the determiner 151 configured to determine presence or absence of an abnormality in the sensor electrode 110 based on a first output signal that is output from the first wire and a second output signal that is output from the second wire, and determine that a detection target is in contact with the surface layer 11A based on the first output signal or the second output signal.

Therefore, it is possible to provide the contact determination apparatus 100 capable of distinguishing between a presence or absence of contact by a hand or the like and damage, such as a crack, in the sensor electrode 110.

The determiner 151 determines that there is no abnormality in the sensor electrode 110 when a first signal value of the first output signal and a second signal value of the second output signal are values that fall within a predetermined range. It is possible to provide the contact determination apparatus 100 capable of distinguishing between presence and absence of damage, such as a crack, in the sensor electrode 110 based on the difference between the first signal value of the first output signal and the second signal value of the second output signal, thereby distinguishing between a presence or absence of contact by a hand or the like and damage, such as a crack, in the sensor electrode 110.

The contact determination apparatus 100 further includes the multiplier 145A1 configured to multiply the first output signal by the sine wave that is in phase with the alternating current signal; the multiplier 145A2 configured to multiply the first output signal by the cosine wave having a phase different by 90 degrees from that of the alternating current signal; the multiplier 145B1 configured to multiply the second output signal by the sine wave; the multiplier 145B2 configured to multiply the second output signal by the cosine wave; the integrator 146A1 configured to integrate an output of the multiplier 145A1 and output the first real signal; the integrator 146A2 configured to integrate an output of the multiplier 145A2 and output the second real signal; the integrator 146B1 configured to integrate the output of the third multiplier 145B1 and output the first imaginary signal; and the integrator 146B2 configured to integrate the output of the multiplier 145B2 and output the second imaginary signal. Since the presence or absence of damage, such as a crack, in the sensor electrode 110 can be determined based on the root sum square of the difference between the first real signal and the second real signal and the difference between the first imaginary signal and the second imaginary signal, it is possible to provide the contact determination apparatus 100 capable of distinguishing between a presence or absence of contact by a hand or the like and damage, such as a crack, in the sensor electrode 110.

The sensor electrode 110 is formed in a belt-like shape, and is fixed to the rim 11 having the surface layer 11A by a plurality of fixing portions in a longitudinal direction of the sensor electrode 110, and a position at which a first impedance seen from the first end portion 111 of the sensor electrode 110 is equal to a second impedance seen from the second end portion 112 of the sensor electrode 110 is different from a plurality of positions at which the plurality of fixing portions are located. Therefore, even if the impedance changes due to a crack or the like at the fixing portion of the sensor electrode 110, an abnormality in the sensor electrode 110 can be reliably detected.

A capacitance between the first end portion 111 of the sensor electrode 110 and a position located at a first distance is different from the capacitance between the second end portion 112 of the sensor electrode 110 and the position located at the first distance. Therefore, even if the impedance changes due to a crack or the like at the plurality of fixing portions of the sensor electrode 110, an abnormality in the sensor electrode 110 can be reliably detected.

The contact determination apparatus further includes a capacitor provided in series between the first end portion 111 of the sensor electrode 110 and an output potential point of the drive circuit 142 or between the second end portion 112 of the sensor electrode 110 and the output potential point of the drive circuit 142. The capacitor is provided so that the capacitance between the first end portion 111 of the sensor electrode 110 and the position located at the first distance differs from the capacitance between the second end portion 112 of the sensor electrode 110 and the position located at the first distance. Therefore, even when a crack has formed in the sensor electrode 110 at the plurality of fixing portions, an abnormality in the sensor electrode 110 can be detected. Therefore, even when a crack has formed in the sensor electrode 110 at the plurality of fixing portions, an abnormality in the sensor electrode 110 can be detected.

The sensor electrode 110 and the shield electrode 120 are fixed to the rim 11 of a steering wheel 10. The surface layer 11A is the surface layer 11A of the rim 11 of the steering wheel 10. The steering wheel 10 has the rim 11, the hub 12, and the spoke 13 connecting the rim 11 and the hub 12. The sensor electrode 110 has the first section in which a front side or an outer peripheral side of the rim 11 between the first end portion 111 and the second end portion 112 is covered; the second section in which a rear side or an inner peripheral side of the rim 11 is covered, the second section being closer to the first end portion 111 and the second end portion 112 than the first section; and the folded-back portion between the first section and the second section, the folded-back portion being folded back from the front side to the rear side of the rim 11 or from the outer peripheral side to the inner peripheral side of the rim 11. The first end portion 111 and the second end portion 112 are located at the spoke 13 or at the hub 12 via the spoke 13. The sensor electrode 110 can be reliably mounted on the steering wheel 10 having a structure in which the sensor electrode 110 cannot be mounted in the circumferential direction of the rim 11 across the spoke 13, and it is possible to detect whether or not the hand H is in contact with the rim 11 in the entire 360-Degree area of the rim 11.

The sensor electrode 110 has a wide section in which the front side and the rear side of the rim 11 or the outer peripheral side and the inner peripheral side of the rim 11 are covered between the first end portion 111 and the second end portion 112, in addition to the first section and the second section. Having the wide section 113 makes it easy to mount the sensor electrode 110 on the rim 11.

The contact determination apparatus further includes a first differential amplifier 141A1 provided in the first wire and having the inverting input terminal and the non-inverting input terminal, the inverting input terminal being connected to the first end portion 111 of the sensor electrode 110; the differential amplifier 141B1 provided in the second wire and having the inverting input terminal and the non-inverting input terminal, the inverting input terminal being connected to the second end portion 112 of the sensor electrode 110; the feedback circuit 141A2 connected between the output terminal of the differential amplifier 141A1 and the inverting input terminal; and the feedback circuit 141B2 connected between the output terminal of the differential amplifier 141B1 and the inverting input terminal. The output terminal of the differential amplifier 141A1 is configured to output the first output signal. The output terminal of the differential amplifier 141B1 is configured to output the second output signal. The input terminal of the multiplier 145A1 and the input terminal of the multiplier 145A2 are connected to the output terminal of the differential amplifier 141A1. The input terminal of the multiplier 145B1 and the input terminal of the multiplier 145B1 are connected to the output terminal of the differential amplifier 141B1. A first real signal, a first imaginary signal, a second real signal, and a second imaginary signal are obtained by the integrators 146A1, 146A2, 146B1, and 146B2 based on a first output signal of the charge amplifier 141A having the differential amplifier 141A1 and the feedback circuit 141A2 and a second output signal of the charge amplifier 141B having the differential amplifier 141B1 and the feedback circuit 141B2.

Although the contact determination apparatus of an exemplary embodiment of the present disclosure has been described above, the present disclosure is not limited to the embodiments specifically disclosed, and various modifications and modifications are possible without departing from the scope of the claims.

What is claimed is:

1. A contact determination apparatus, comprising:
a detection electrode having a first end portion and a second end portion positioned at both ends and provided along a contact portion;
a shield electrode provided facing the detection electrode and capacitively coupled to the detection electrode;
an alternating current signal outputter configured to output an alternating current signal to the detection electrode or the shield electrode;
a first wire connected to the first end portion of the detection electrode;
a second wire connected to the second end portion of the detection electrode; and
a determiner configured to determine presence or absence of an abnormality in the detection electrode based on a first output signal that is output from the first wire and a second output signal that is output from the second wire, and determine that a detection target is in contact with the contact portion based on the first output signal or the second output signal.

2. The contact determination apparatus according to claim 1, wherein
the determiner is configured to determine that there is no abnormality in the detection electrode when a first signal value of the first output signal and a second signal value of the second output signal are values that fall within a predetermined range.

3. The contact determination apparatus according to claim 2, further comprising:
a first multiplication circuit configured to multiply the first output signal by a first alternating current signal that is in phase with the alternating current signal;
a second multiplication circuit configured to multiply the first output signal by a second alternating current signal having a phase different by 90 degrees from that of the alternating current signal;
a third multiplication circuit configured to multiply the second output signal by the first alternating current signal;
a fourth multiplication circuit configured to multiply the second output signal by the second alternating current signal;
a first integration circuit configured to integrate an output of the first multiplication circuit and output a first conversion value;
a second integration circuit configured to integrate an output of the second multiplication circuit and output a second conversion value;
a third integration circuit configured to integrate an output of the third multiplication circuit and output a third conversion value; and
a fourth integration circuit configured to integrate an output of the fourth multiplication circuit and output a fourth conversion value.

4. The contact determination apparatus according to claim 1, wherein
the detection electrode is formed in a belt-like shape, and is fixed to a fixation target having the contact portion by a plurality of fixing portions in a longitudinal direction of the detection electrode, and
a position at which a first impedance seen from the first end portion of the detection electrode is equal to a second impedance seen from the second end portion of the detection electrode is different from a plurality of positions at which the plurality of fixing portions are located.

5. The contact determination apparatus according to claim 4, wherein
a capacitance between the first end portion of the detection electrode and a position located at a first distance is different from a capacitance between the second end portion of the detection electrode and the position located at the first distance.

6. The contact determination apparatus according to claim 5, further comprising:
a capacitor provided in series between the first end portion of the detection electrode and an output potential point of a drive circuit or between the second end portion of the detection electrode and the output potential point of the drive circuit, wherein
the capacitor is provided so that a capacitance between the first end portion of the detection electrode and the position located at the first distance differs from a capacitance between the second end portion of the detection electrode and the position located at the first distance.

7. The contact determination apparatus according to claim 1, wherein
the detection electrode and the shield electrode are fixed to a rim of a steering wheel,
the contact portion is a surface layer of the rim of the steering wheel,
the steering wheel has the rim, a hub, and a spoke connecting the rim and the hub,
the detection electrode has
a first section in which a front side or an outer peripheral side of the rim between the first end portion and the second end portion is covered;
a second section in which a rear side or an inner peripheral side of the rim is covered, the second section being closer to the first end portion and the second end portion than the first section; and
a folded-back portion between the first section and the second section, the folded-back portion being folded back from the front side to the rear side of the rim or from the outer peripheral side to the inner peripheral side of the rim, and
the first end portion and the second end portion are located at the spoke or at the hub via the spoke.

8. The contact determination apparatus according to claim 7, wherein
the detection electrode has a wide section in which the front side and the rear side of the rim or the outer peripheral side and the inner peripheral side of the rim are covered between the first end portion and the second end portion, in addition to the first section and the second section.

9. The contact determination apparatus according to claim 3, further comprising:
a first differential amplifier provided in the first wire and having a first terminal and a second terminal, the first terminal being connected to the first end portion of the detection electrode;
a second differential amplifier provided in the second wire and having a third terminal and a fourth terminal, the third terminal being connected to the second end portion of the detection electrode;
a first feedback circuit connected between an output terminal of the first differential amplifier and the first terminal; and
a second feedback circuit connected between an output terminal of the second differential amplifier and the third terminal, wherein the output terminal of the first differential amplifier is configured to output the first output signal,
the output terminal of the second differential amplifier is configured to output the second output signal,
an input terminal of the first multiplication circuit and an input terminal of the second multiplication circuit are connected to the output terminal of the first differential amplifier, and
an input terminal of the third multiplication circuit and an input terminal of the fourth multiplication circuit are connected to the output terminal of the second differential amplifier.
